(19) United States
(12) Patent Application Publication
(10) Pub. No.: US 2026/0276780 A1
(43) Pub. Date: Sep. 17, 2026

(54) INTEGRATED CIRCUIT PACKAGING CONFIGURATIONS FOR TERAHERTZ ACTIVE SENSING

(71) Applicant: TeraDar, Inc., Boston, MA (US)

(72) Inventors: Ruiyang Liu, Negaunee, MI (US); Gregory L. Charvat, Guilford, CT (US); Nicholas Saiz, San Jose, CA (US); Matthew Carey, Watertown, MA (US); Volker Alois Blaschke, Irvine, CA (US)

(73) Assignee: TeraDar, Inc., Boston, MA (US)

(21) Appl. No.: 19/562,456

(22) Filed: Mar. 10, 2026

Related U.S. Application Data
(60) Provisional application No. 63/770,908, filed on Mar. 12, 2025.

(51) Int. Cl. G01S 7/03; G01S 7/282; G01S 7/285; G01S 13/10; H01Q 21/06

(52) U.S. Cl. CPC G01S 7/032; G01S 7/282; G01S 7/285; H01Q 21/065; G01S 13/10

(57) ABSTRACT

Described herein are improved integrated transmitter and/or receiver circuits that may be implemented in a Terahertz-based active sensing system (e.g., operating. According to some embodiments, integrated transmitter and/or receiver circuits described herein may have a conductive layer including an antenna array and a semiconductor die with integrated circuitry disposed between the conductive layer and a substrate on which the integrated circuit is mounted. Some embodiments described herein exhibit high power gain in a compact footprint, which may increase the detection range of a Terahertz-based active sensing system on a given link budget.

### BACKGROUND

Most vehicles available today are equipped with sensors capable of sensing the surrounding environment, which helps drivers operate vehicles more safely in difficult driving situations, contributing significantly to the reduction of vehicle-related accidents such as collisions. It is expected that the use of advanced sensing technologies will accelerate across all segments of the vehicle market, which will help significantly reduce vehicle-related accidents, resulting in fewer injuries and fatalities. It is also expected that the use of advanced sensing technologies at all levels of automation within the vehicle market will make mass implementation of automated vehicles safer. The development and deployment of advanced vehicle-based sensing require significant advances in technology.

### SUMMARY

Some embodiments provide for a radar device, comprising: a substrate defining a plane extending in a first direction and in a second direction substantially orthogonal to the first direction; and a transmitter comprising a transmit integrated circuit mounted on the substrate, the transmit integrated circuit comprising: a first conductive layer comprising a transmit antenna array, the transmit antenna array comprising a plurality of transmit RF antennas; and a transmit semiconductor die disposed between the first conductive layer and the substrate, the transmit semiconductor die having integrated thereon transmit circuitry configured to cause at least some of the plurality of transmit RF antennas to transmit first RF signals having a center frequency in a range between 150 GHz and 1.5 THz. In some embodiments, the first RF signals have a center frequency in a range between 300 GHz and 320 THz.

In some embodiments, the transmit integrated circuit further comprises a second conductive layer disposed between the transmit semiconductor die and the substrate.

In some embodiments, each of the plurality of transmit RF antennas comprises a patch antenna.

In some embodiments, the plurality of transmit RF antennas are arranged in a first column along the first direction and a second column along the first direction, the first column comprises a first subset of the plurality of transmit RF antennas and the second column comprises a second subset of the plurality of transmit RF antennas; and the first subset of the plurality of transmit RF antennas are mirrored with respect to the second subset of the plurality of transmit RF antennas across a line of symmetry.

In some embodiments, the radar device further comprises a receiver comprising a receive integrated circuit mounted on the substrate and comprising: a receive antenna array comprising a plurality of receive RF antennas; and receive circuitry configured to receive second RF signals via the plurality of receive RF antennas, the second RF signals being generated, at least in part, based on reflection of the first RF signals from a target object. In some embodiments, the receive integrated circuit comprises: a first conductive layer comprising the receive antenna array; and a receive semiconductor die disposed between the first conductive layer and the substrate and having the receive circuitry integrated thereon. In some embodiments, the radar device further comprises signal generation circuitry mounted on the substrate and configured to generate third RF signals, wherein the transmit circuitry is configured to generate the first RF signals using the third RF signals, and wherein the receive circuitry is configured to mix the second RF signals with the third RF signals to obtain fourth RF signals. In some embodiments, a radar device further comprises processing circuitry mounted on the substrate and configured to determine, based on the fourth RF signals, a distance from the radar device to the target object.

In some embodiments, the transmitter comprises a plurality of transmit integrated circuits mounted on the substrate and spaced at a distance from one another in the first direction, the plurality of transmit integrated circuits comprising the transmit integrated circuit, and each of the plurality of transmit integrated circuits comprising: a first conductive layer comprising a transmit antenna array comprising a plurality of transmit RF antennas; and a transmit semiconductor die disposed between the first conductive layer and the substrate and having integrated thereon transmit circuitry configured to transmit, via the plurality of transmit RF antennas, first RF signals having a center frequency in a range between 150 GHz and 1.5 THz.

In some embodiments, the transmit circuitry comprises a transmit amplifier and a frequency multiplier.

In some embodiments, the transmit integrated circuit comprises a plurality of vias electrically coupled between the plurality of transmit RF antennas and the transmit circuitry.

Some embodiments provide for a radar device, comprising: a substrate defining a plane extending in a first direction and a second direction substantially orthogonal to the first direction; a transmitter comprising a transmit integrated circuit mounted on the substrate, comprising: a first conductive layer comprising a transmit antenna array, the transmit antenna array comprising a plurality of transmit RF antennas; and a transmit semiconductor die disposed between the first conductive layer and the substrate and having integrated thereon transmit circuitry configured to cause at least some of the plurality of transmit RF antennas to transmit first RF signals having a center frequency in a range between 150 GHz and 1.5 THz; a receiver comprising a receive integrated circuit mounted on the substrate, the receive integrated circuit comprising: a first conductive layer comprising a receive antenna array comprising a plurality of receive RF antennas; and a receive semiconductor die disposed between the first conductive layer and the substrate and having integrated thereon receive circuitry configured to receive, via the plurality of receive RF antennas, second RF signals generated, at least in part, by reflection of the first RF signals off of a target object; and processing circuitry mounted on the substrate and configured to determine, based on the second RF signals, a distance between the radar device and the target object. In some embodiments, the first RF signals have a center frequency in a range between 300 GHz and 320 THz.

In some embodiments, the transmit integrated circuit further comprises a second conductive layer disposed between the transmit semiconductor die and the substrate.

In some embodiments, each of the plurality of transmit RF antennas comprises a patch antenna. In some embodiments, each of the plurality of receive RF antennas comprises a patch antenna.

In some embodiments, the plurality of transmit RF antennas are arranged in a first column along the first direction and a second column along the first direction, the first column comprises a first subset of the plurality of transmit RF antennas and the second column comprises a second subset of the plurality of transmit RF antennas; and the first subset of the plurality of transmit RF antennas are mirrored with respect to the second subset of the plurality of transmit RF antennas across a line of symmetry.

In some embodiments, the radar device further comprises signal generation circuitry mounted on the substrate and configured to generate third RF signals, wherein the transmit circuitry is configured to generate the first RF signals using the third RF signals, and wherein the receive circuitry is configured to mix the second RF signals with the third RF signals to obtain fourth RF signals.

In some embodiments, the transmitter comprises a plurality of transmit integrated circuits mounted on the substrate and spaced at a distance from one another in the first direction, the plurality of transmit integrated circuits comprising the transmit integrated circuit, and each of the plurality of transmit integrated circuits comprising: a first conductive layer comprising a transmit antenna array comprising a plurality of transmit RF antennas; and a transmit semiconductor die disposed between the first conductive layer and the substrate and having integrated thereon transmit circuitry configured to transmit, via the plurality of transmit RF antennas, first RF signals having a center frequency in a range between 150 GHz and 1.5 THz; and the receiver comprises a plurality of receive integrated circuits mounted on the substrate and spaced at a distance from one another in the second direction, the plurality of receive integrated circuits comprising the receive integrated circuit, and each of the plurality of receive integrated circuits comprising: a first conductive layer comprising a receive antenna array comprising a plurality of receive RF antennas; and a receive semiconductor die having integrated thereon receive circuitry configured to receive, via the plurality of receive RF antennas, second RF signals generated, at least in part, by reflection of the first RF signals off of a target object.

In some embodiments, the transmit circuitry comprises a transmit amplifier and a frequency multiplier.

In some embodiments, the transmit integrated circuit comprises a plurality of vias electrically coupled between the plurality of transmit RF antennas and the transmit circuitry.

In some embodiments, the radar device further comprises interface circuitry mounted on the substrate, wherein the receive circuitry is configured to process the second RF signals to obtain third RF signals, the interface circuitry is configured to digitize the third RF signals to obtain fourth RF signals, and the processing circuitry is configured to determine the distance based on the fourth RF signals.

Some embodiments provide for a radar device, comprising: a substrate defining a plane extending in a first direction and in a second direction substantially orthogonal to the first direction; and a receiver comprising a receive integrated circuit mounted on the substrate, the receive integrated circuit comprising: a first conductive layer comprising a receive antenna array, the receive antenna array comprising a plurality of receive RF antennas; and a receive semiconductor die disposed between the first conductive layer and the substrate, the receive semiconductor die having integrated thereon receive circuitry configured to receive, via at least some of the plurality of receive RF antennas, first RF signals having a center frequency in a range between 150 GHz and 1.5 THz. In some embodiments, the first RF signals have a center frequency in a range between 300 GHz and 320 THz.

In some embodiments, the receive integrated circuit further comprises a second conductive layer disposed between the receive semiconductor die and the substrate.

In some embodiments, each of the plurality of receive RF antennas comprises a patch antenna.

In some embodiments, the radar device further comprises a transmitter comprising a transmit integrated circuit mounted on the substrate and comprising: a transmit antenna array comprising a plurality of transmit RF antennas; and transmit circuitry configured to cause the plurality of transmit RF antennas to transmit second RF signals, the first RF signals being generated, at least in part, based on reflection of the second RF signals from a target object. In some embodiments, the transmit integrated circuit comprises: a first conductive layer comprising the transmit antenna array; and a transmit semiconductor die disposed between the first conductive layer and the substrate and having the transmit circuitry integrated thereon. In some embodiments, the radar device further comprises signal generation circuitry mounted on the substrate and configured to generate third RF signals, wherein the transmit circuitry is configured to generate the second RF signals using the third RF signals, and wherein the receive circuitry is configured to mix the first RF signals with the third RF signals to obtain fourth RF signals. In some embodiments, the radar device further comprises processing circuitry mounted on the substrate and configured to determine, based on the fourth RF signals, a distance from the radar device to the target object.

In some embodiments, the receiver comprises a plurality of receive integrated circuits mounted on the substrate and spaced at a distance from one another in the second direction, the plurality of receive integrated circuits comprising the receive integrated circuit, and each of the plurality of receive integrated circuits comprising: a first conductive layer comprising a receive antenna array comprising a plurality of receive RF antennas; and a receive semiconductor die disposed between the first conductive layer and the substrate and having integrated thereon receive circuitry configured to receive, via the plurality of receive RF antennas, first RF signals having a center frequency in a range between 150 GHz and 1.5 THz.

In some embodiments, the receive circuitry comprises a receive amplifier and a frequency mixer.

In some embodiments, the receive integrated circuit comprises a plurality of vias electrically coupled between the plurality of receive RF antennas and the receive circuitry.

Some embodiments provide for a radar device, comprising: a substrate defining a plane extending in a first direction and in a second direction substantially orthogonal to the first direction; and an integrated circuit mounted on the substrate, the integrated circuit comprising: a first conductive layer comprising an antenna array, the antenna array comprising a plurality of RF antennas; and a semiconductor die disposed between the first conductive layer and the substrate, the semiconductor die having integrated thereon circuitry configured to transmit and/or receive, via at least some of the plurality of RF antennas, first RF signals having a center frequency in a range between 150 GHz and 1.5 THz. In some embodiments, the first RF signals have a center frequency in a range between 300 GHz and 320 THz.

In some embodiments, the antenna array comprises a transmit antenna array and the semiconductor die comprises transmit circuitry configured to transmit the first RF signals via the at least some of the plurality of RF antennas. In some embodiments, the antenna array comprises a receive antenna array and the semiconductor die comprises receive circuitry configured to receive the first RF signals via the at least some of the plurality of RF antennas. In some embodiments, the antenna array comprises a transmit and receive antenna array; the semiconductor die comprises transmit circuitry configured to transmit a first subset of the first RF signals via the at least some of the plurality of RF antennas; the semiconductor die comprises receive circuitry configured to receive a second subset of the first RF signals via the at least some of the plurality of RF antennas; and the second subset of the first RF signals are generated, at least in part, by reflection of the first subset of the first RF signal off of a target object.

Some embodiments provide for an integrated circuit for a radar device, the integrated circuit comprising: a mounting interface; a first conductive layer comprising an antenna array, the antenna array comprising a plurality of RF antennas; and a semiconductor die disposed between the first conductive layer and the mounting interface, the semiconductor die having integrated thereon circuitry configured to transmit and/or receive, via at least some of the plurality of RF antennas, first RF signals having a center frequency in a range between 150 GHz and 1.5 THz.

### BRIEF DESCRIPTION OF DRAWINGS

Various aspects and embodiments will be described with reference to the following figures. It should be appreciated that that the figures are not necessarily drawn to scale.

FIG. 1 illustrates an example radar device transmitting and receiving RF signals, in accordance with some embodiments of the technology described herein.

FIG. 2 illustrates an example radar device having a transmitter with a transmit antenna array and a receiver with a receive antenna array, in accordance with some embodiments of the technology described herein.

FIG. 3A illustrates example circuitry including signal generation circuitry and a transmitter having a transmit semiconductor die that may be included in a radar device, in accordance with some embodiments of the technology described herein.

FIG. 3B illustrates example transmit circuitry that may be included in the transmitter of FIG. 3A, in accordance with some embodiments of the technology described herein.

FIG. 4A illustrates example signal generation circuitry, a receiver, interface circuitry, and processing circuitry that may be included in a radar device, in accordance with some embodiments of the technology described herein.

FIG. 4B illustrates example receive circuitry that may be included in the receiver of FIG. 4A, in accordance with some embodiments of the technology described herein.

FIG. 5 illustrates an example integrated circuit that may be included in the transmitter of FIG. 3A and/or the receiver of FIG. 4A, in accordance with some embodiments of the technology described herein.

FIG. 6 illustrates an alternative example integrated circuit that may be included in the transmitter of FIG. 3A and/or the receiver of FIG. 4A, in accordance with some embodiments of the technology described herein.

FIG. 7A illustrates a conductive layer of a further alternative example integrated circuit that may be included in the transmitter of FIG. 3A and/or the receiver of FIG. 4A, in accordance with some embodiments of the technology described herein.

FIG. 7B illustrates the conductive layer and a semiconductor die of the integrated circuit of FIG. 7A, in accordance with some embodiments of the technology described herein.

FIG. 8 illustrates example interface circuitry that may be included in the radar device of FIG. 2, in accordance with some embodiments of the technology described herein.

FIG. 9 illustrates an example computer system that may be configured to perform at least some processing operations in the radar device of FIG. 2, in accordance with some embodiments of the technology described herein.

### DETAILED DESCRIPTION

Described herein are improved integrated transmitter and/or receiver circuits that may be implemented in a Terahertz-based active sensing system (e.g., operating. According to some embodiments, integrated transmitter and/or receiver circuits described herein may have a conductive layer including an antenna array and a semiconductor die with integrated circuitry between the conductive layer and a substrate on which the circuit is mounted. Such configurations exhibit high power efficiency (e.g., realized gain) in a compact footprint, which may increase the detection range of a Terahertz-based active sensing system on a given link budget.

The inventors have developed an active radio-frequency (RF) sensing technology, operating in the Terahertz band, for determining the relative and/or absolute state (e.g., position, velocity, and/or acceleration) of a target object (e.g., a static target object such as a lamp post, a utility pole, a building, or a dynamic target object such as a person, a vehicle, a car, a truck, etc.). The terms “radio-frequency” and “RF” are used herein to refer to electromagnetic signals having frequency content in the 0-3 THz band. The term “Terahertz” is used herein to refer to radio-frequency signals having frequency content in the 300 GHz-3 THz band (including the end points).

Advantages of Terahertz-based active sensing compared to prior sensing techniques are described in U.S. Pat. No. 12,105,181. For example, operating RADAR at Terahertz frequencies (300 GHz-3 THz) is advantageous because the wide bandwidth available for signals in these frequency ranges provides for high range resolution, which is important for some automotive applications. At higher frequencies more bandwidth is available for transmission, which in turn increases the range resolution of the resulting RADAR system.

However, despite the advantages of Terahertz-based active sensing, the inventors have recognized that developing Terahertz-based active sensing systems presents its own challenges. For example, atmospheric attenuation at higher frequencies in the THz spectrum (e.g., at 850 GHz) limits the ability of a RADAR system to detect targets at longer distances applications (e.g., at a distance of 300 meters) at a given link budget (e.g., less than 20 Watts), which may be relevant in certain applications such as some automotive applications.

Atmospheric attenuation poses a major challenge. By the time an RF signal travels from a transmitter to a target object, and upon reflection, from the target object to the receiver, the power level of the RF signal is attenuated near or below the receiver's noise floor. Therefore, the receiver's ability distinguish RF signals from noise is significantly impaired.

Indeed, Terahertz signals are more susceptible to atmospheric attenuation than millimeter waves or infrared light. Terahertz signals undergo absorption by water vapor and oxygen molecules in the atmosphere. For this reason, atmospheric attenuation degrades with increasing humidity. For example, at 100 GHz, the atmospheric attenuation is well below 3 dB/km, regardless of the humidity. At 300 GHz, the atmospheric attenuation is between 10 dB/km and 40 dB/km. At 700 GHz, the atmospheric attenuation is above 100 dB/km.

The inventors have identified several solutions to mitigate the effects of atmospheric attenuation. The solutions described herein may be used individually or in combination. One solution stems from the inventors' appreciation that the atmospheric attenuation exhibits local attenuation minima. While attenuation can be quite severe, as high as 1000 dB/km in some bands, some frequency bands exhibit local minima. For example, atmospheric attenuation drops substantially in frequency bands near 310 GHz, 425 GHz, 475 GHz, 670 GHz, and 850 GHz. Recognizing this behavior, active sensing systems according to some embodiments are designed to operate in one or more of these frequency bands in which the atmospheric attenuation exhibits local minima.

The inventors have therefore recognized that there are frequency ranges in the THz band which provide a practical compromise between making available large bandwidths (for increased range resolution), while keeping atmospheric attenuation to manageable levels such that at these frequency ranges a RADAR system can range to objects at distances needed for various applications (e.g., up to 300 meters in some automotive applications) at a fixed link budget (e.g., less than 10 or 20 Watts). These ranges include, for example, 300 to 320 GHz, 390 to 450 GHz, 440 to 480 GHz, 455 to 495 GHz, and 820 to 880 GHz. In addition, millimeter wave frequency bands could be considered such as, for example, bands in the range of 190 to 300 GHz, because these bands nevertheless involve operating at higher frequencies than conventional millimeter wave RADAR systems (which operate at lower center frequencies still, e.g., under 100 GHz, which limits their available bandwidth) and therefore provide for improved range resolution, while even further mitigating the impact of atmospheric attenuation.

The inventors have also developed techniques for implementing transmitters and receivers exhibiting high power gain to counteract losses due to atmospheric attenuation. One such solution involves novel packaging configurations for transmit and/or receive integrated circuitry. These techniques are described further below.

### Overview of Terahertz RADAR Device

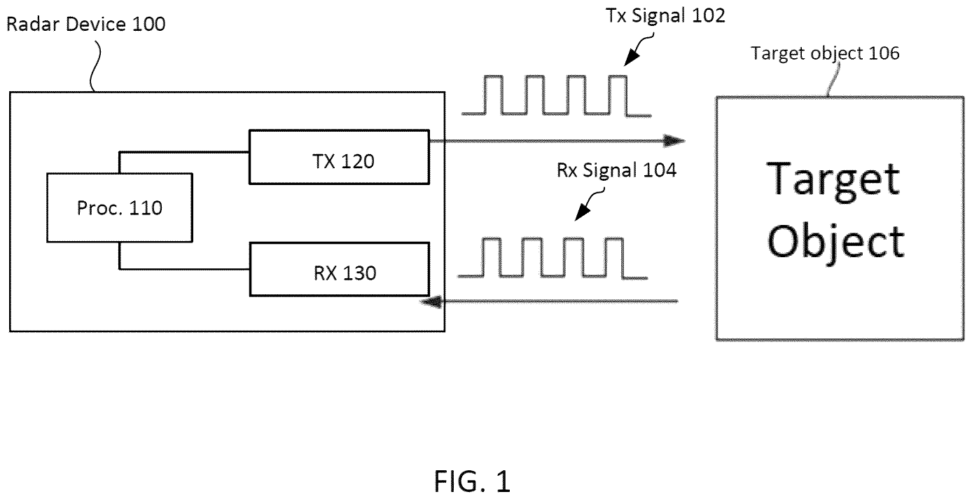

FIG. 1 illustrates an example radar device 100 transmitting and receiving RF signals, in accordance with some embodiments of the technology described herein.

As shown in FIG. 1, the radar device 100 has a transmitter (TX) 120 and a receiver (RX) 130. In some embodiments, TX 120 may include transmit circuitry (analog and/or digital) configured to generate RF transmit signals (e.g., pulses, as shown in FIG. 1) for transmission via a transmit antenna array. In some embodiments, RX 130 may include receive circuitry (analog and/or digital) configured to receive RF signals via a receive antenna array, the RF receive signals generated at least in part by reflection of RF transmit signals from a target object 106.

Also shown in FIG. 1, the radar device 100 includes processing circuitry 110. In some embodiments, processing circuitry 110 may include analog and/or digital circuitry and/or may be implemented, for example, using one or more field programmable gate arrays (FPGA), one or more application-specific integrated circuits (ASICs), one or more processors, and/or one or more microcontrollers. In some embodiments, processing circuitry 110 may be configured to control operation of radar device 100, such as to control timing of RF signal transmission and/or reception, and/or processing circuitry 110 may be configured to process data obtained by radar device 100, such as to generate (e.g., range-cross range) images using received RF signals. According to various embodiments, processing circuitry 110 may be packaged on the same substrate (e.g., printed circuit board) hosting the transmit and/or receive circuitry of radar device 200, and/or processing circuitry 110 may be packaged separately therefrom.

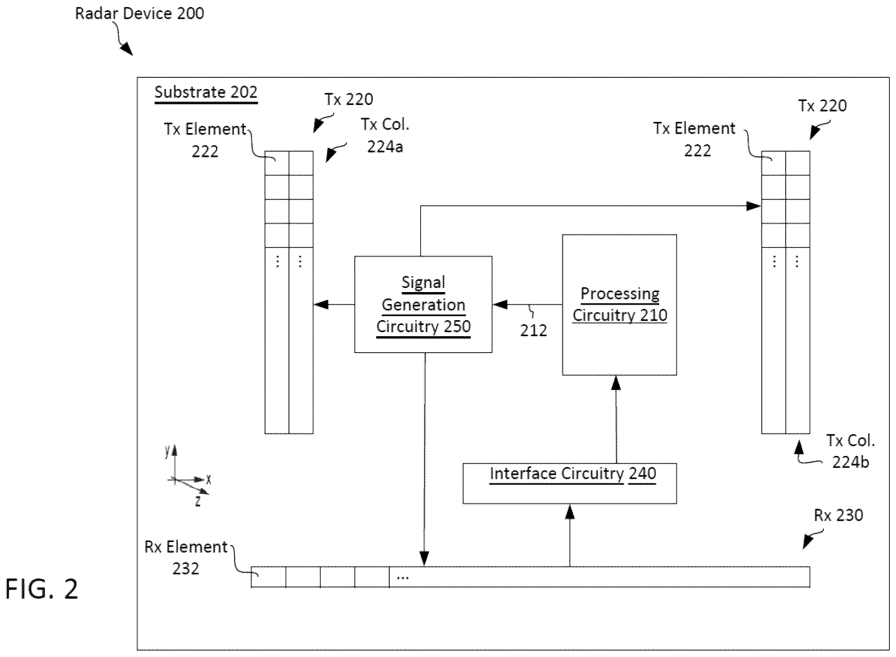

FIG. 2 illustrates an example radar device 200 having a transmitter (TX) 220 with a transmit antenna array and a receiver (RX) 230 with a receive antenna array, in accordance with some embodiments of the technology described herein.

As shown in FIG. 2, radar device 200 includes a substrate 202 having processing circuitry 210, signal generation circuitry 250, TX 220, RX 230, and interface circuitry 240 thereon.

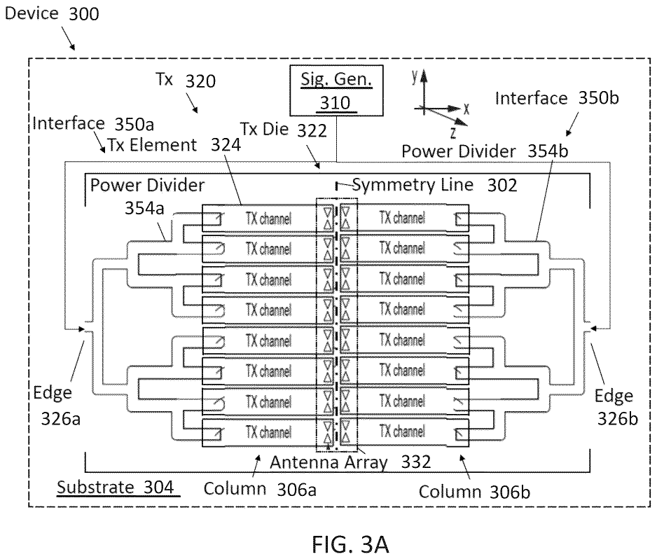

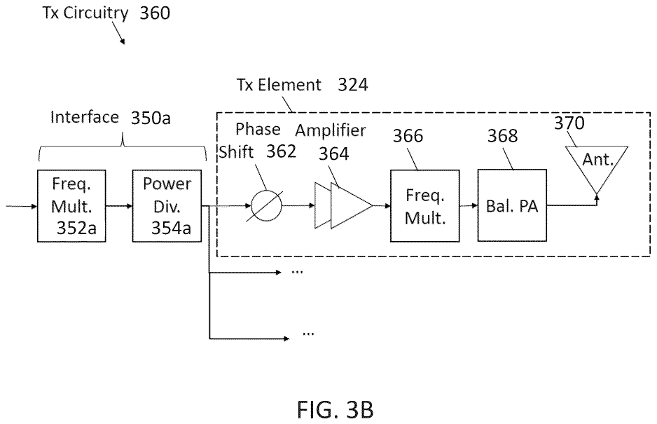

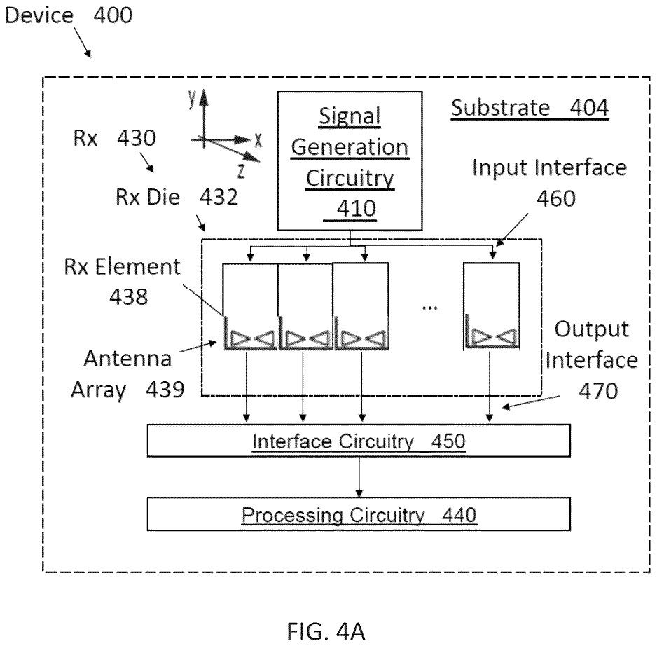

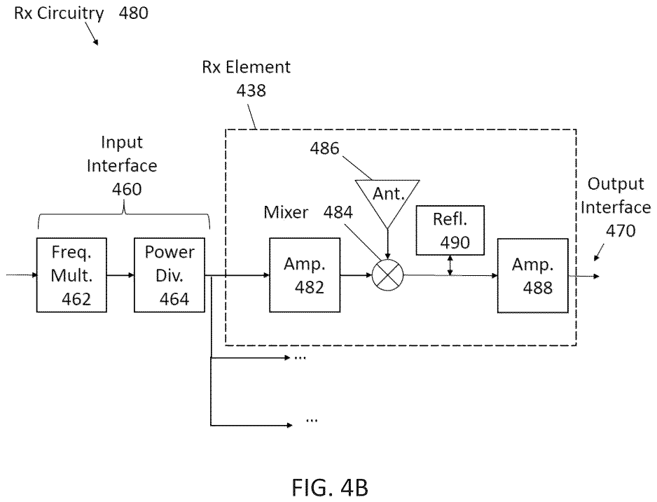

In some embodiments, TX 220 and RX 230 may be mounted on substrate 202. For example, TX 220 and RX 230 may include components integrated on one or more semiconductor dies that are mounted (e.g., using wire bonds and/or a ball-grid-array) on substrate 202. For instance, as shown in FIG. 2, TX 220 has a transmit antenna array including transmit antenna elements 222, which may be integrated on a plurality of transmit semiconductor dies (e.g., 1122 in FIG. 3A) mounted on substrate 202. Similarly, as shown in FIG. 2, RX 230 has a receive antenna array including receive antenna elements 232, which may be integrated on a plurality of receive semiconductor dies (e.g., 1432 in FIG. 4A) mounted on substrate 202. In some embodiments, semiconductor dies of TX 220 and/or RX 230 may be mounted directly on substrate 202, and/or may be mounted on one or more interposers, with the interposer(s) mounted directly on substrate 202.

As shown in FIG. 2, TX 220 has a transmit antenna array including transmit antenna elements 222. Each transmit antenna element may be sized to emit signals having frequency content in the frequency band of 150 GHz-3 THz or any frequency band within the 150 GHz-3 THz band (e.g., 190-300 GHz, 300-320 GHz, 307-313 GHz, 390-450 GHz, 440-480 GHz, 455-495 GHz, 660-700 GHz, or 820-880 GHz). For example, transmit antenna elements 222 may be sized to emit signals having frequency content in the frequency band of 300-320 GHz or 307-313 GHz. In some embodiments, transmit antenna elements described herein may have a frequency bandwidth (e.g., 3 dB bandwidth) of 1 GHz-4 GHz, 1.5 GHZ, 3 GHZ, 4 GHZ-134 GHz, 4 GHZ-100 GHz, 4 GHZ-60 GHz, 10 GHz-100 GHz, 10 GHz-60 GHz, 10 GHz-30 GHz, 15 GHZ-60 GHz, 10 GHz-30 GHz or 15 GHz-25 GHz. Similarly, RX 230 has receive antenna elements 232 that may be sized to receive signals having frequency content in a frequency band of 150 GHz-3 THz or any sub-band of this frequency band. For example, in some embodiments, receive antenna elements 232 may be sized to receive signals having frequency content in a frequency band of 300-320 GHz or 307-313 GHz. In some embodiments, receiver 330 has a frequency bandwidth of 10 GHz-60 GHz, 10 GHZ-30 GHz, 15 GHZ-60 GHz, 10 GHz-30 GHz or 15 GHz-25 GHz.

In some embodiments, TX 220 may be configured to transmit RF signals outside the plane defined by the top surface of substrate 202 (e.g., parallel to the z-axis or at any angle relative to the z-axis other than 90 deg.). For example, a transmit antenna array of TX 220 may be shaped to have a main lobe extending away from the plane defined by the top surface of substrate 202. Similarly, RX 230 may be configured to receive the transmitted signals upon reflection from a target object. For example, a receive antenna array of RX 230 may be shaped to have a main lobe extending away from the plane defined by the top surface of substrate 202.

In some embodiments, TX 220 may have multiple columns of transmit antenna elements extending in one direction and spaced from one another in an orthogonal direction. For example, as shown in FIG. 2, a first pair of columns of transmit antenna elements 222a extends along the y-direction and a second pair of columns of transmit antenna elements 222b extend along the y-direction and are spaced from the first pair of columns along the x-direction.

In some embodiments, interface circuitry 240 may be configured to offload signals from RX 230 and provide the offloaded signals to processing circuitry 210. For example, interface circuitry 240 may include ADC circuitry coupled to RX 230. In some embodiments, ADC circuitry may be implemented using mixed-signal ASICs (e.g., having analog front end (AFE) components of RX 230 and ADC components of interface circuitry 440 coupled to processing circuitry 210). In some embodiments, interface circuitry 240 may be mounted on substrate 202, either directly, or on an interposer. Alternatively or additionally, at least some AFE and/or ADC circuitry may be located in a same integrated circuit package (e.g., on the same die(s)) as processing circuitry 210. For instance, processing circuitry 210 may include an FPGA and/or ASIC having ADC circuitry therein.

In some embodiments, processing circuitry 210 may include digital circuits and/or analog circuits configured to determine the relative and/or absolute state of a target object (e.g., 106 in FIG. 1), such as a distance between device 200 and the target object, based on the reflected signals received from the RX 430 and/or to generate range-cross range images using the reflected signals. Processing circuitry 210 may be mounted on substrate 202, such as shown in FIG. 4A (e.g., on another die such as an FPGA, ASIC, and/or processor), and/or processing circuitry 210 may be integrated on a semiconductor die of RX 230, or, at least in part, on another substrate.

In some embodiments, processing circuitry 210 may be configured to control operation of radar device 200. For example, as shown in FIG. 2, processing circuitry 210 may be configured to provide a control signal 212 to signal generation circuitry 250 that controls signal generation circuitry 250 to generate a reference RF signal for transmission and/or reception using TX 220 and/or RX 230.

While all components are shown mounted on one substrate in FIG. 2, it should be appreciated that, in some embodiments, TX 220 and RX 230 may be mounted on a first substrate and processing circuitry 210 may be mounted on a second substrate that is communicatively coupled to the first substrate. For instance, TX 220 and RX 230 may be mounted on a first side of the first substrate, interface circuitry 240 may be mounted on a second side of the first substrate, and processing circuitry 210 may be mounted on a side of the second substrate that faces the second side of the first substrate. It should be appreciated that other arrangements are possible (e.g., with interface circuitry 240 on the same side of a substrate as TX 220 and RX 230).

FIG. 3A is a schematic view of a substrate 304 having a transmitter 320, which may be included in a device, e.g., 300, in accordance with some embodiments of the technology described herein.

In some embodiments, device 300 may be configured as described herein for device 100 and/or 200 including in connection with FIGS. 1-2. For example, as shown in FIG. 3A, device 300 includes substrate 304 having mounted thereon signal generation circuitry 310 and transmitter 320.

In some embodiments, transmitter 320 may have a transmit semiconductor die having integrated thereon transmit circuitry (360, FIG. 3B) configured to generate RF signals based on a reference RF signal, and transmitter 320 may further include a transmit antenna array having RF antennas configured to transmit the RF signals. For example, as shown in FIG. 3A, transmitter 320 has a transmit semiconductor die 322 with a plurality of transmit elements 324 and transmit antenna array 332. For instance, each transmit element 324 may have a portion of the transmit circuitry configured to feed a respective transmit antenna of transmit antenna array 332. In other embodiments, such as described further herein, transmit antenna array 332 may not be integrated on transmit semiconductor die 322.

In some embodiments, an RF transmit antenna array may have a transmit aperture with a transmit aperture length extending in a first direction and a transmit aperture width extending in a second direction, the transmit aperture length being larger than the transmit aperture width. For example, as shown in FIG. 3A, antenna array 332 has more antennas in the y direction than in the x direction, which pay provide a larger transmit aperture length in the y direction than transmit aperture width in the x direction.

In some embodiments, transmit semiconductor die 322 may have an RF transmit antenna array arranged in a two-dimensional grid. For example, as shown in FIG. 3A, transmit antenna array 332 is arranged in first and second columns 306a and 306 extending in the first direction (e.g., y-direction), with each column having multiple rows extending in the second direction (e.g., x-direction). In some embodiments, the RF transmit circuitry onboard transmit semiconductor die 322 may be further arranged in the two-dimensional grid. For example, transmit circuitry of transmit elements 324 may be arranged in a first transmit circuitry portion in first column 306a and configured to feed the antennas in first column 306a and a second transmit circuitry portion in second column 306b configured to feed the antennas in second column 306b. For instance, the first transmit circuitry portion may include the transmit circuitry of transmit elements 324 shown in first column 306a in FIG. 3A and the second transmit circuitry portion may include the transmit circuitry of transmit elements 324 shown in second column 306b in FIG. 3A. In FIG. 3A, first and second columns 306a and 306b have 8 rows, though it should be appreciated that any number of rows may be included, such as two or more rows (e.g., more rows than columns).

In some embodiments, transmit semiconductor die 322 may have components with mirror symmetry across a line extending in the first direction. For example, in FIG. 3A, first and second columns 306a and 306b of transmit antenna array 332 mirror one another across a symmetry line 302 that separates first and second columns 306a and 306b. For instance, antennas of transmit antenna array 332 in first column 306a may have mirror symmetry with corresponding antennas of transmit antenna array 332 in second column 306b. In some embodiments, the first and second transmit circuitry portions may be further mirrored across symmetry line 302 separating first and second columns 306a and 306b. For example, a first transmit circuitry portion, including transmit circuitry in first column 306a configured to feed antennas of first column 306a, may have mirror symmetry with a second transmit circuitry portion across symmetry line 302, the second transmit circuitry portion including transmit circuitry in second column 306b configured to feed antennas of second column 306b.

In some embodiments, transmit semiconductor die 322 may further include multiple interfaces configured to receive a reference RF signal from signal generation circuitry 310 and provide the reference RF signal to transmit elements 324. For example, in FIG. 3A, transmit semiconductor die 322 has a first interface 350a and a second interface 350b, with first interface 350a coupled between signal generation circuitry 310 and transmit elements 324 of first column 306a and second interface 350b coupled between signal generation circuitry 310 and transmit elements 324 of second column 306b.

In some embodiments, first interface 350a may be positioned within a threshold distance of a first outer edge of transmit semiconductor die 322 and second interface 350b may be positioned within the threshold distance of a second outer edge of transmit semiconductor die 322 opposite the first outer edge. For example, as shown in FIG. 3A, transmit semiconductor die 322 has a first outer edge 326a and a second outer edge 326b that is opposite first outer edge 326a (e.g., along the x-axis), and first interface 350a includes a first power divider 354a disposed proximate first outer edge 326a and second interface 350b includes a second power divider 354b disposed proximate second outer edge 326b. In some embodiments, first power divider 354a may be positioned within a threshold distance of first outer edge 326a and second power divider 354b may be positioned within the threshold distance of second outer edge 326b. For instance, the threshold distance may be a distance from the outer edge of the die in which bond pads are disposed for connecting to substrate 304 (e.g., via wire bond). It should be appreciated that first and second power dividers 354a and 354b may both be within the same threshold distance of respective outer edges 326a and 326b without necessarily being spaced identically from respective outer edges 326a and 326b (e.g., one power divider may be more closely spaced to the respective outer edge). It should also be appreciated that in other mounting configurations (e.g., BGA mount), an outer edge may be the edge closest to which the corresponding connections to the substrate (e.g., solder balls) are disposed.

In some embodiments, power dividers of transmit semiconductor die 322 may be configured to divide a reference RF signal from signal generation circuitry 310 into a plurality of reference RF signals and provide the plurality of reference RF signals to transmit circuitry of transmit semiconductor die 322 for feeding antenna array 332. For example, power divider 354a may be configured to receive a reference RF signal from signal generation circuitry 310 (e.g., via bonds pads at first outer edge 326a), divide the reference RF signal into a reference RF signal for each respective antenna of first column 306a, and provide the reference RF signals to the respective antennas of first column 306a. Similarly, power divider 354b may be configured to receive the reference RF signal from signal generation circuitry 310 (e.g., via bond pads at second outer edge 326b), divide the reference RF signal into a reference RF signal for each respective antenna of second column 306b, and provide the reference RF signals to the respective antennas of second column 306b. For instance, as shown in FIG. 3A, first and second columns 306a and 306b have 8 rows of transmit elements 324, and power dividers 354a and 354b are each configured as a 1-to-8 (1:8) power divider.

In some embodiments, transmit circuitry of transmit semiconductor die 322 may be configured to propagate reference RF signals, from first and second interfaces 350a and 350b to respective first and second columns 306a and 306b of antenna array 332, in opposite propagation directions. For example, in FIG. 3A, transmit circuitry of transmit elements 324 in first column 306a may be configured to propagate the reference RF signals from power divider 354a in a first propagation direction (e.g., parallel to the x-direction) from first outer edge 326a to antenna array 332, and transmit circuitry of transmit elements 324 in second column 306b may be configured to propagate the reference RF signals from power divider 354b in a second propagation direction (e.g., parallel to the x-direction) from second outer edge 326b to antenna array 332. For instance, in FIG. 3A, first and second outer edges 326a and 326b are opposite one another along the x-axis, and the first and second propagation directions are opposite one another along the x-axis.

While a single transmit semiconductor die 322 is shown in FIG. 3A, a device may have multiple transmit semiconductor dies 322 shown as configured in FIG. 3A, such as organized into one or more columns, such as shown in FIG. 2. For example, transmit semiconductor die 322 may be a first die and device 300 may further include a second transmit semiconductor die configured as described herein for die 322, with mirror symmetry across symmetry line 302. Alternatively or additionally, device 300 may further include a transmit semiconductor die configured as described herein for die 322, with mirror symmetry across another symmetry line (e.g., extending parallel to the y-axis).

In some embodiments, transmitter 320 may include a transmit antenna array distributed over multiple transmit semiconductor dies 322, such as with the transmit antenna array 339 of a transmit semiconductor die 322 being configured as a subset of the transmit antenna array of the transmitter 320. For example, transmit semiconductor dies 322 may be spaced at a distance from one another (e.g., in a column) that limits center-to-center spacing between transmit antennas 370 at adjacent edges of the transmit semiconductor dies 322 to about one-half wavelength or less.

While signal generation circuitry 310 is shown on the same substrate 304 as transmit semiconductor die 324 in FIG. 3A, signal generation circuitry 310 may be on a separate substrate in some embodiments.

In some embodiments, device 300 may further have a receiver (e.g., 230 in FIG. 2) with a receive antenna array having a receive aperture with a receive aperture length extending in the first direction (e.g., y direction) and a receive aperture width extending in the second direction (e.g., x direction), the receive aperture length being smaller than the receive aperture width, such as described above and further herein.

FIG. 3B is a circuit diagram of transmit circuitry 360 of transmitter 320, in accordance with some embodiments of the technology described herein.

In some embodiments, interface 350a may further include frequency multiplication circuitry configured to up-convert a reference RF signal from signal generation circuitry 310 to a center frequency of or closer to the center frequency of transmission. For example, where signal generation circuitry 310 and transmit semiconductor die 322 are mounted on substrate 304, the reference RF signal may be propagated from signal generation circuitry 310 to transmit semiconductor die 322 using traces on substrate 304, which may not have suitable characteristics for propagating signals at THz frequencies. Rather, in some embodiments, the reference RF signal may be propagated from signal generation circuitry 310 to transmit semiconductor die 322 at a relatively low center frequency (e.g., 17.22 GHz), and interface 350a may have a frequency multiplier 352a configured to up-convert the reference RF signal to a center frequency (e.g., 155 GHz) closer to transmit center frequency (e.g., 310 GHz). In the illustrated embodiment, frequency multiplier 364a is configured to provide the up-converted reference RF signal to power divider 354a to be divided among transmit elements 324. For example, frequency multiplication may be less noisy to perform a signal having a large power level (e.g., prior to power division.

In some embodiments, transmit semiconductor die 322 may have transmit circuitry 360 configured to generate RF signals based on the reference RF signal obtained from signal generation circuitry 310 and feed the RF signals to transmit antenna array 332. For example, as shown in FIG. 3B, transmit element 324 includes an antenna 370 of transmit antenna array 332a coupled to a phase shifter 362, amplifier 364, frequency multiplier 366, a balanced power amplifier 368 of transmit circuitry 360.

In some embodiments, phase shifter 362 may be configured to introduce a beamforming phase shift to RF signals transmitted by antenna 370, such as with phase shifters 362 of some or all transmit elements 324 providing a different phase shift so as to steer transmitted RF signals at a particular angle (e.g., in elevation and/or azimuth). In some embodiments, amplifier 364 may be configured to add power to phase shifted signals prior to multiplication by frequency multiplier 366, which may mitigate at least some noise from frequency multiplication.

In some embodiments, frequency multiplier 366 may be configured to output an RF signal having a center frequency desired for transmission via antenna 370. For example, in FIG. 3B, some frequency multiplication to reach the center frequency desired for transmission may be performed by frequency multiplier 352a of interface 350a and some frequency multiplication may be performed by frequency multiplier 366. For instance, a 9× multiplication may be performed by frequency multiplier 352a (e.g., from 17.22 GHz to 155 GHz), and a 2× multiplication (e.g., frequency doubling) may be performed by frequency multiplier 366. For instance, frequency multiplication by a larger scalar may be performed with less noise impact on signals having higher power levels, such as 9× multiplication on a received reference RF signal at full power followed by 2× multiplication on several reference RF signals divided from the reference RF signal into smaller power levels.

In some embodiments, balanced power amplifier 368 may be configured to amplify the RF signal to a power level suitable for transmission via antenna 370. For instance, the power level may be set based on a desired transmission range (e.g., object detection range) and the known attenuation at the center frequency of the transmitted RF signal. In some embodiments, a balanced power amplifier may be used where antenna 370 is fed using a balanced feed, (e.g., for a balanced fed dipole or patch), whereas an unbalanced power amplifier may be used antenna 370 is fed using an unbalanced feed (e.g., for an unbalanced fed dipole, patch, or monopole).

While not shown in FIG. 3B, it should be appreciated that power divider 354a may be coupled to the transmit elements 324 of first column 306a, and that power divider 354b may be coupled to transmit elements 324 of second column 306b and configured as described herein for (e.g., mirrored with respect to) the portion of device 300 shown in FIG. 3B.

FIG. 4A is a schematic view of a substrate 404 of example receiver 430, interface circuitry 450, and processing circuitry 440, which may be included in a device, e.g., 400, in accordance with some embodiments of the technology described herein. FIG. 4B is a circuit diagram of a receive element 438 of receiver 430, in accordance with some embodiments of the technology described herein.

In some embodiments, device 400 may be configured as described herein for device 100 and/or 200 including in connection with FIGS. 1-2. For example, as shown in FIG. 4A, device 400 includes substrate 404 having mounted thereon signal generation circuitry 410, receiver 430, interface circuitry 450, and processing circuitry 440.

In some embodiments, receiver 430 may have a receive semiconductor die with receive circuitry, and receiver 430 may further include a receive antenna array. For example, in FIG. 4A, receiver 430 includes receive semiconductor die 432 including receive elements 438 and receive antenna array 439. For instance, each receive element 438 may include an antenna of antenna array 439 and receive circuitry 480 configured to feed (e.g., obtain received RF signals via) the antenna. In other embodiments, such as described further herein, the receive antenna array may not be integrated on receive semiconductor die 432.

In some embodiments, an RF receive antenna array may have a receive aperture with a receive aperture length extending in a first direction and a receive aperture width extending in a second direction, the receive aperture length being smaller than the receive aperture width. For example, as shown in FIG. 4A, antenna array 439 has more antennas in the x direction than in the y direction, which pay provide a larger receive aperture length in the x direction than receive aperture width in the y direction.

In some embodiments, receiver 430 may be configured to obtain a reference RF signal from signal generation circuitry 410. For example, as shown in FIG. 4A, receive semiconductor die 432 further includes an input interface 460 configured to receive a reference RF signal from signal generation circuitry 410. For instance, the reference RF signal may be propagated from signal generation circuitry 410 to receive semiconductor die 432 via traces on substrate 404 and provided to bond pads of input interface 460. And, as further shown in FIG. 4B, interface 460 includes a frequency multiplier 462 and power divider 464, which may be configured as described herein for frequency multiplier 352a and power divider 354a of transmit semiconductor die 322, respectively, in some embodiments. For instance, frequency multiplier 454a may be configured to up-convert the reference RF signal to a higher center frequency (e.g., from 17.22 GHz to 155 GHZ) for mixing with received RF signals, and power divider 452b may be configured to divide the reference RF signal among multiple receive elements 438 for providing to amplifiers 482. In some embodiments, frequency multiplier 454a may be configured to up-convert the reference RF signal to a center frequency lower than the center frequency of received RF signals, such as for mixing using a sub-harmonic mixer as described above. While not shown in FIG. 4B, it should be appreciated that power divider 452a may be coupled to the receive elements 438 of receive semiconductor die 432 as described herein for the portion of device 400 shown in FIG. 4B.

In some embodiments, receive circuitry 480 may be configured to mix RF signals, received via antenna array 439, with a reference RF signal. For example, as shown in FIG. 4B, receive element 438 includes an antenna 486 of antenna array 439 and a portion of receive circuitry 480 that includes a first amplifier 482, a mixer 484 coupled to antenna 486, and a second amplifier 488 coupled to mixer 484. In some embodiments, first amplifier 482 may be configured to obtain and provide a reference RF signal to mixer 484, such as described further below. In some embodiments, mixer 484 may be configured to mix an RF signal, received via antenna 486, with the reference RF signal obtained via first amplifier 482 to output a mixed signal. In some embodiments, second amplifier 488 may be configured to amplify and provide the mixed signal to an output interface 470 of receive semiconductor die 432 (e.g., for offloading via interface circuitry 450).

In some embodiments, mixer 484 may be configured to output the mixed signal having a center frequency indicative of a distance between device 400 and a target object from which the received RF signal was received by antenna 486. For example, the received RF signal and the reference RF signal may be LFM signals that, when mixed, produce a mixed signal having a center frequency indicating a time delay between transmission of an RF signal (e.g., based on the reference RF signal) and reception of the received RF. In some embodiments, mixer 484 may be configured as a sub-harmonic mixer. For example, the reference RF signal obtained via amplifier 482 may have a harmonic having the center frequency of the RF signal obtained via antenna 486, and mixer 484 may be configured to mix the RF signal obtained via antenna 486 with that harmonic of the reference RF signal. For instance, mixer 484 may be configured as a second sub-harmonic mixer configured to mix a second harmonic (e.g., center frequency of 310 GHz) of the reference RF signal (e.g., center frequency of 155 GHZ) with the RF signal (e.g., center frequency of 310 GHz) obtained via antenna 486, though other sub-harmonics, such as even-integer sub-harmonics may be used.

In some embodiments, receive circuitry 480 may further include a reflector coupled between a mixer and an amplifier and configured to reflect at least some RF energy generated by the mixer back into the mixer. For example, as shown in FIG. 4B, receive element 438 further includes reflector 490 coupled between mixer 484 and amplifier 488. In some embodiments, a reflector 490 may be included for each antenna 486 of antenna array 439, such as between a mixer 484 and amplifier 488 of each receive element 438 of receive semiconductor die 432.

In some embodiments, including reflector 490 in a receive element 438 may improve the gain and/or efficiency of receiver 430. For example, mixer 484 may be configured to obtain an RF signal having a first center frequency (e.g., 310 GHz) via antenna 486 and output a mixed signal having a second center frequency (e.g., 3 GHZ) to amplifier 488, which may result in at least some RF energy at the first center frequency leaving mixer 484 toward amplifier 488. For instance, the RF energy may include a voltage and/or current wave having the first center frequency. In some embodiments, reflector 490 may be configured to reflect RF energy, at least at the first center frequency (of the RF signal received via antenna 486) back into mixer 484. For example, reflecting RF energy at the first center frequency back into mixer 484 may recycle at least some of the RF energy at the first center frequency into RF energy in the mixed signal output by mixer 484, thereby increasing the gain and/or efficiency (e.g., output power vs. input power) of mixer 484. In some embodiments, increases in gain and/or efficiency of mixers may thereby increase the sensitivity of the receiver to RF signals at low power levels (e.g., attenuated due to reception from farther away).

In some embodiments, interface circuitry 450 may include AFE and/or ADC circuitry mounted on substrate 404 and configured to receive mixed signals via receiver 430 (e.g., amplifier 488). For example, interface circuitry 450 may include AFE and/or ADC circuitry integrated on receive semiconductor die 432, such as with the AFE circuitry coupled to amplifier 488 on-die. Alternatively or additionally, AFE and/or ADC circuitry may be on one or more separate dies, such as a mixed-signal ASIC, and/or within an integrated circuit package with at least a portion of processing circuitry 440.

While a single receive semiconductor die 432 is shown in FIG. 4A, a device may have multiple receive semiconductor dies 432 shown as configured in FIG. 4A, such as organized into one or more rows, such as shown in FIG. 2. For example, receive semiconductor die 432 may be a first die (e.g., 432a) and device 400 may further include a second receive semiconductor die (e.g., 432b) configured as described herein for die 432 and disposed in a row with the first die along the x-direction.

In some embodiments, receiver 430 may include a receive antenna array distributed over multiple receive semiconductor dies 432, such as with the receive antenna array 439 of a receive semiconductor die 432 being configured as a subset of the receive antenna array of the receiver 430. For example, receive semiconductor dies 432 may be spaced at a distance from one another (e.g., in a row) that limits center-to-center spacing between receive antennas 486 at adjacent edges of the receive semiconductor dies 432 to about one-half wavelength or less.

While signal generation circuitry 410 is shown on the same substrate 404 as receive semiconductor die 432 in FIG. 4A, signal generation circuitry 410 may be on a separate substrate in some embodiments.

In some embodiments, device 400 may further have a transmitter (e.g., 220) mounted on substrate 404 and configured to receive the reference RF signal from signal generation circuitry 410, generate RF signals using the reference RF signal (e.g., by up-converting and dividing the reference RF signals), and feed the RF signals to a plurality of RF transmit antennas. In some embodiments, the transmitter may have a transmit antenna array having a transmit aperture with a transmit aperture length extending in the first direction (e.g., y direction) and a transmit aperture width extending in the second direction (e.g., x direction), the transmit aperture length being greater than the transmit aperture width, such as described above.

While FIGS. 3A-4B illustrate examples of transmit semiconductor dies with transmit antenna arrays and receive semiconductor dies with receive antenna arrays, it should be appreciated that other examples include transmit and receive semiconductor dies and/or transmit and receive antenna arrays. For example, an antenna array may be configured as a transmit antenna array and as a receive antenna array as described herein including in connection with FIGS. 3A and 4A. Alternatively or additionally, transmit circuitry and receive circuitry as described herein including in connection with FIGS. 3B and 4B may be implemented on a semiconductor die and coupled to respective transmit and receive antenna arrays, and/or to a transmit and receive antenna array.

### Integrated Circuit Packaging Techniques

As described above, the inventors have developed solutions to mitigate the effects of atmospheric attenuation on transmitted and/or received signals in a Terahertz RADAR device. Some solutions involve novel packaging configurations for transmit and/or receive integrated circuitry, which provide high power gain at Terahertz frequencies.

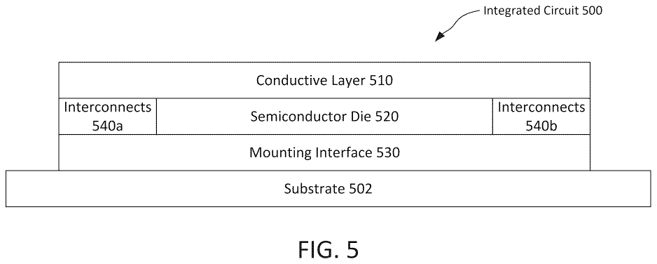

The inventors have recognized that, at Terahertz frequencies, the packaging configuration of a transmit and/or receive integrated circuit may significantly impact gain of signals transmitted and/or received using the integrated circuit. For example, such an integrated circuit may have transmit and/or receive circuitry and a transmit and/or receive antenna array. From a circuit design perspective, it can be advantageous to implement the circuitry and the antenna array on a semiconductor die and then package the die (e.g., using wafer-level chip-scale packaging) for mounting on a substrate (e.g., as described herein including in connection with FIG. 5). On the other hand, implementing the antenna array on the semiconductor die with the circuitry may cause too much radiated signal power to be lost in the packaging layers around the die to be used in some applications.

Accordingly, some embodiments provide an integrated circuit in which a transmit and/or receive semiconductor die is disposed between a conductive layer, having an antenna array, and a mounting interface of the integrated circuit. By packaging the semiconductor die between the conductive layer and the mounting interface, the antenna array on the conductive layer may be configured to transmit and/or receive signals with low loss in the packaging layers of the integrated circuit, resulting in high power gain. In some embodiments, an encapsulation layer may be disposed over the conductive layer to protect the antenna array.

It should be appreciated that some embodiments may include packaging configurations in which circuitry and an antenna array are implemented on a semiconductor die, as the present disclosure is not so limited. For example, a transmit integrated circuit may be implemented with a conductive layer having an antenna array and a semiconductor die having circuitry disposed between the conductive layer and mounting interface and a receive integrated circuit may be implemented with circuitry and an antenna array implemented on a semiconductor die, and/or vice versa.

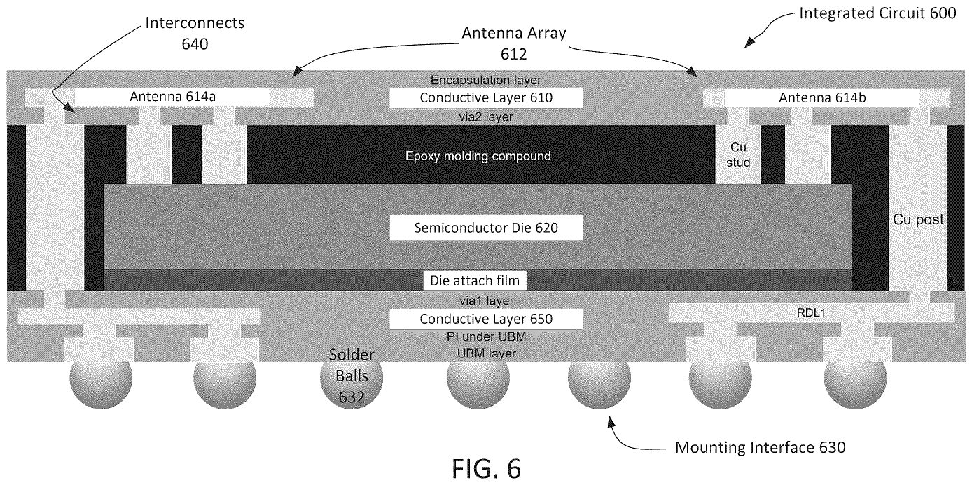

In some embodiments provide a radar device (e.g., 200 in FIG. 2), comprising a substrate (e.g., 202) defining a plane extending in a first direction (e.g., y-direction in FIG. 2) and in a second direction (e.g., x-direction in FIG. 2) substantially orthogonal to the first direction and an integrated circuit (e.g., 500 in FIG. 5) mounted on the substrate, the integrated circuit comprising a first conductive layer (e.g., 510) comprising an antenna array (e.g., 612 in FIG. 6), the antenna array comprising a plurality of RF antennas (e.g., 614a, 614b) and a semiconductor die (e.g., 520 in FIG. 5) disposed between the first conductive layer and the substrate, the semiconductor die having integrated thereon circuitry (e.g., Tx circuitry 360 in FIG. 3B and/or Rx circuitry 480 in FIG. 4B) configured to transmit and/or receive, via at least some of the plurality of RF antennas, first RF signals having a center frequency in a range between 150 GHz and 1.5 THz.

In some embodiments, the first RF signals have a center frequency in a range between 300 GHz and 320 THz. In some embodiments, the first RF center frequency is in a range of 190 to 300 GHz, 300 to 320 GHz, 390 to 450 GHz, 440 to 480 GHz, 455 to 495 GHz, 660 to 700 GHz, or 820 to 880 GHz. In some embodiments, the first RF center frequency is between 300 GHz and 320 GHz. In some embodiments, the first RF signals have a bandwidth of at least 2 GHz, at least 3 GHZ, or at least 6 GHz.

In some embodiments, the first conductive layer may include a redistribution layer (RDL) of the integrated circuit. For example, the first conductive layer may include an upper RDL overlying the semiconductor die.

In some embodiments, the integrated circuit further comprises a second conductive layer (e.g., 640 in FIG. 6) disposed between the semiconductor die and the substrate. For example, the second conductive layer may include a second RDL below the semiconductor die. In some embodiments, the integrated circuit further comprises a mounting interface (e.g., 530 in FIG. 5), such as a ball-grid-array (BGA) mounting interface but not limited thereto.

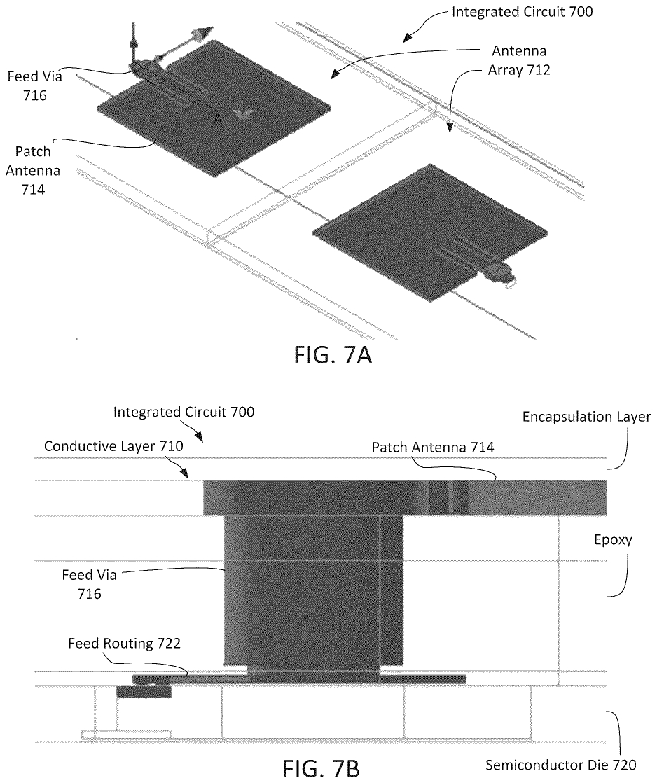

In some embodiments, the integrated circuit comprises a plurality of vias (e.g., 716 in FIG. 7A) electrically coupled between the plurality of RF antennas and the circuitry. For example, the plurality of vias may be configured to feed the RF antennas for transmission and/or reception using the circuitry.

In some embodiments, each of the plurality of RF antennas comprises a patch antenna (e.g., 714 in FIG. 7A). For example, patch antennas may be configured to transmit and/or receive circularly polarized RF signals, which may be useful in RADAR applications, but the present disclosure is not limited thereto. Other antenna configurations are possible, such as dipole antennas.

In some embodiments, the radar device comprises a transmitter (e.g., 320 in FIG. 3A) comprising the integrated circuit configured as a transmit integrated circuit, the antenna array is configured as a transmit antenna array (e.g., 332) comprising a plurality of transmit RF antennas (e.g., 370 in FIG. 3B), and the semiconductor die is configured as a transmit semiconductor die (e.g., 322 in FIG. 3A) having transmit circuitry (e.g., 360 in FIG. 3B) integrated thereon and configured to cause at least some of the plurality of transmit RF antennas to transmit the first RF signals.

In some embodiments, the plurality of transmit RF antennas are arranged in a first column (e.g., 306a in FIG. 3A) along the first direction (e.g., the y-direction) and a second column (e.g., 306b) along the first direction, the first column comprises a first subset (e.g., 614a) of the plurality of transmit RF antennas and the second column comprises a second subset (e.g., 614b) of the plurality of transmit RF antennas. For example, a multi-column configuration of transmit RF antennas may provide a larger antenna aperture than the same number of transmit RF antennas implemented in a single-column, resulting in high power gain. In some embodiments, the first subset of the plurality of transmit RF antennas are mirrored with respect to the second subset of the plurality of transmit RF antennas across a line of symmetry (e.g., 302). For example, a mirrored configuration may simplify the layout of the semiconductor die because an input signal may be distributed separately to the plurality of RF antennas and associated transmit circuitry in each column.

In some embodiments, the radar device further comprises a receiver (e.g., 430 in FIG. 4A) comprising a receive integrated circuit mounted on the substrate and comprising a receive antenna array (e.g., 439) comprising a plurality of receive RF antennas (e.g., 486 in FIG. 4B) and receive circuitry (e.g., 480) configured to receive second RF signals via the plurality of receive RF antennas, the second RF signals being generated, at least in part, based on reflection of the first RF signals from a target object (e.g., 106 in FIG. 1).

In some embodiments, the receive integrated circuit comprises a first conductive layer (e.g., 510 in FIG. 5) comprising the receive antenna array and a receive semiconductor die (e.g., 520) disposed between the first conductive layer and the substrate and having the receive circuitry integrated thereon.

In some embodiments, the radar device further comprises signal generation circuitry (e.g., 250 in FIG. 2) mounted on the substrate and configured to generate third RF signals, wherein the transmit circuitry is configured to generate the first RF signals using the third RF signals, and wherein the receive circuitry is configured to mix the second RF signals with the third RF signals to obtain fourth RF signals.

In some embodiments, the radar device further comprises processing circuitry (e.g., 210 in FIG. 2) mounted on the substrate and configured to determine, based on the fourth RF signals, a distance from the radar device to the target object.

In some embodiments, the transmitter comprises a plurality of transmit integrated circuits (e.g., 500 in FIG. 5) mounted on the substrate and spaced at a distance from one another in the first direction (e.g., the y-direction), the plurality of transmit integrated circuits comprising the transmit integrated circuit, and each of the plurality of transmit integrated circuits comprising first conductive layer (e.g., 510) comprising a transmit antenna array (e.g., 612 in FIG. 6) comprising a plurality of transmit RF antennas (e.g., 614a, 614b) and a transmit semiconductor die (e.g., 520 in FIG. 5) disposed between the first conductive layer and the substrate and having integrated thereon transmit circuitry (e.g., 360 in FIG. 3B) configured to transmit, via the plurality of transmit RF antennas, first RF signals having a center frequency in a range between 150 GHz and 1.5 THz.

In some embodiments, the transmit circuitry comprises a transmit amplifier (e.g., 368 in FIG. 3B) and a frequency multiplier (e.g., 366).

In some embodiments, the radar device comprises a receiver (e.g., 430 in FIG. 4A) comprising the integrated circuit configured as a receive integrated circuit, the antenna array is configured as a receive antenna array (e.g., 439) comprising a plurality of receive RF antennas (e.g., 486 in FIG. 4B), and the semiconductor die is configured as a receive semiconductor die (e.g., 432 in FIG. 4A) having receive circuitry (e.g., 480 in FIG. 4B) integrated thereon and configured to receive, via at least some of the plurality of receive RF antennas, the first RF signals.

In some embodiments, the radar device further comprises a transmitter (e.g., 320 in FIG. 3A) comprising a transmit integrated circuit mounted on the substrate and comprising a transmit antenna array (e.g., 332) comprising a plurality of transmit RF antennas (e.g., 370 in FIG. 3B) and transmit circuitry (e.g., 360 in FIG. 3B) configured to cause the plurality of transmit RF antennas to transmit second RF signals, the first RF signals being generated, at least in part, based on reflection of the second RF signals from a target object (e.g., 106 in FIG. 1).

In some embodiments, wherein the transmit integrated circuit (e.g., 500 in FIG. 5) comprises a first conductive layer (e.g., 510) comprising the transmit antenna array (e.g., 612 in FIG. 6) and a transmit semiconductor die (e.g., 520 in FIG. 5) disposed between the first conductive layer and the substrate and having the transmit circuitry integrated thereon.

In some embodiments, the radar device further comprises signal generation circuitry (e.g., 250 in FIG. 2) mounted on the substrate and configured to generate third RF signals, wherein the transmit circuitry is configured to generate the second RF signals using the third RF signals, and wherein the receive circuitry is configured to mix the first RF signals with the third RF signals to obtain fourth RF signals.

In some embodiments, the radar device further comprises processing circuitry (e.g., 210 in FIG. 2) mounted on the substrate and configured to determine, based on the fourth RF signals, a distance from the radar device to the target object.

In some embodiments, the receiver comprises a plurality of receive integrated circuits (e.g., 500 in FIG. 5) mounted on the substrate and spaced at a distance from one another in the second direction (e.g., the x-direction), the plurality of receive integrated circuits comprising the receive integrated circuit, and each of the plurality of receive integrated circuits comprising a first conductive layer (e.g., 510) comprising a receive antenna array (e.g., 612 in FIG. 6) comprising a plurality of receive RF antennas (e.g., 614a, 614b) and a receive semiconductor die (e.g., 520 in FIG. 5) disposed between the first conductive layer and the substrate and having integrated thereon receive circuitry (e.g., 480 in FIG. 4B) configured to receive, via the plurality of receive RF antennas, first RF signals having a center frequency in a range between 150 GHz and 1.5 THz.

In some embodiments, the receive circuitry comprises a receive amplifier (e.g., 488 in FIG. 4B) and a frequency mixer (e.g., 484).

FIG. 5 illustrates an example integrated circuit 500 that may be included in the transmitter 320 of FIG. 3A and/or the receiver 430 of FIG. 4A, in accordance with some embodiments of the technology described herein.

In some embodiments, integrated circuit 500 may be included in transmitter 320 as a transmit integrated circuit and/or in receiver 430 as a receive integrated circuit. For example, integrated circuit 500 may include a transmit semiconductor die 322 of transmitter 320 and/or a receive semiconductor die 432 of receiver 430. In some embodiments, integrated circuit 500 may be configured as a transmit and receive semiconductor die, as the present disclosure is not so limited.

As shown in FIG. 5, integrated circuit 500 includes a conductive layer 510, a semiconductor die 520, and a mounting interface 530. In the illustrated example, semiconductor die 520 is disposed between conductive layer 510 and mounting interface 530. In some embodiments, semiconductor die 520 may be configured as a transmit semiconductor die, such as described herein for transmit semiconductor die 322. Alternatively or additionally, in some embodiments, semiconductor die 520 may be configured as a receive semiconductor die, such as described herein for receive semiconductor die 432.

In some embodiments, conductive layer 510 may include an antenna array including a plurality of RF antennas. For example, the antenna array may be configured as a transmit antenna array including a plurality of transmit RF antennas such as described herein for transmit antenna array 332. Alternatively or additionally, the antenna array may be configured as a receive antenna array including a plurality of receive RF antennas such as described herein for receive antenna array 439. In some embodiments, conductive layer 510 may be configured as an RDL of integrated circuit 500. For example, conductive layer 510 may include conductive portions (e.g., feed lines to the antenna array) carrying RF signals to and/or from semiconductor die 520.

In some embodiments, semiconductor die 520 may have integrated thereon circuitry configured to transmit and/or receive, via at least some of the RF antennas of the antenna array, first RF signals having a center frequency in a range between 150 GHz and 1.5 THz. For example, circuitry integrated on semiconductor die 520 may be configured as transmit circuitry such as described herein for transmit circuitry 360. Alternatively or additionally, circuitry integrated on semiconductor die 520 may be configured as receive circuitry such as described herein for receive circuitry 480.

In some embodiments, circuitry of semiconductor die 520 may be configured to transmit and/or receive the first RF signals via interconnects 540a and 540b. For example, interconnects 540a and 540b may include vias electrically coupled between antennas of the antenna array and the circuitry, such as to feed the antennas for transmission and/or reception of the first RF signals. In some embodiments, interconnects 540a and/or 540b may be alternatively or additionally configured to route signals from mounting interface 530 to semiconductor die 520. For example, interconnects 540a and/or 540b may be configured to provide RF signals from signal generation circuitry (e.g., 250 in FIG. 2) to circuitry on semiconductor die 520.

In some embodiments, conductive layer 510 may include an antenna for each transmit and/or receive element of semiconductor die 520 (e.g., transmit element 324 in FIG. 3A and/or receive element 438 in FIG. 3B). For example, in a single-ended transmit and/or receive configuration, a single antenna of conductive layer 510 may be electrically coupled to each transmit and/or receive element. Alternatively or additionally, in a differential transmit and/or receive configuration, a pair of antennas of conductive layer 510 may be electrically coupled to each transmit and/or receive element. It should be appreciated that a differential transmit and/or receive configuration may be implemented with a single antenna electrically coupled to each transmit and/or receive element, such as where the single antenna has a differential feed.

In some embodiments, mounting interface 530 may be configured to mounting to substrate 502. For example, mounting interface 530 may be configured as a BGA mounting interface, though other mounting interfaces may be used such as land grid array (LGA) mounting interface and/or a through-hole mounting interface.

In some embodiments, integrated circuit 500 may be manufactured using wafer-level packaging (WLP), such as fan-out WLP (FOWLP). For example, semiconductor die 520 may be fabricated and diced from a wafer and then packaged with mounting interface 530 attached to one side of the die 520 (e.g., below the die in FIG. 5), and with conductive layer 510 attached to another side of the die (e.g., above the die in FIG. 5). In some embodiments, interconnects 540a and 540b may be formed on the side of semiconductor die 520 to which conductive layer 510 is attached, such as before attaching conductive layer 510. In some embodiments, semiconductor die 520 may be molded with epoxy before conductive layer 510 is attached thereto. In some embodiments, an additional conductive layer (e.g., RDL) may be disposed between semiconductor die 520 and mounting interface 530, such as to route signals from mounting interface 530 to semiconductor die 520. In some embodiments, encapsulation may be disposed over conductive layer 510 to protect the antenna array.

In some embodiments, a transmitter (e.g., 320) and/or receiver (e.g., 430) may include a plurality of integrated circuits 500 mounted on semiconductor die 520 and spaced at a distance from one another. For example, in the configuration of FIG. 2, integrated circuits 500 configured as transmit integrated circuits may be spaced at a distance from one another in the y-direction. Alternatively or additionally, in the configuration of FIG. 2, integrated circuits 500 configured as receive integrated circuits may be spaced at a distance from one another in the x-direction. In some embodiments, antenna arrays of adjacent integrated circuits 500 may be spaced by about a half-wavelength at the center frequency of the first RF signals or less (e.g., within 10% of a half-wavelength thereof). For example, the distance between adjacent edges of the adjacent integrated circuits 500, as well as distances between the antenna arrays and the edges, may provide such a distance between the antenna arrays. For instance, spacing by about a half-wavelength or less may partially or entirely prevent grating lobes due to spatial aliasing in the transmitter and/or receiver.

FIG. 6 illustrates an alternative example integrated circuit 600 that may be included in the transmitter 320 of FIG. 3A and/or the receiver 430 of FIG. 4A, in accordance with some embodiments of the technology described herein.

In some embodiments, integrated circuit 600 may be configured as described herein for integrated circuit 500. For example, as shown in FIG. 6, integrated circuit 600 includes a conductive layer 610, a semiconductor die 620, and mounting interface 630. In the illustrated example, conductive layer 610 includes an antenna array 612 electrically coupled to semiconductor die 620, and mounting interface 630 is configured as a BGA mounting interface including solder balls 632 and an under-bump metallization (UBM) layer.

In some embodiments, antenna array 612 may include a plurality of RF antennas. For example, as shown in FIG. 6, antenna array 612 includes a first antenna 614a and a second antenna 614b. For example, first antenna 614a and 614b may be configured as patch antennas, though other configurations as possible such as dipole antenna configurations. In the illustrated embodiment, antenna array 612 is electrically coupled to semiconductor die 620 by interconnects 640, which may include vias such as configured to feed first antenna 614a and second antenna 614b. For instance, interconnects 640 may be electrically coupled between antenna array 612 and transmit and/or receive circuitry integrated on semiconductor die 620. In the illustrated example of FIG. 6, interconnects 640 are further shown including posts (“Cu post”) electrically coupled between mounting interface 630 and semiconductor die 620, such as to distribute signals from mounting interface 630 to the side of semiconductor die 620 that is attached to conductive layer 610.

In some embodiments, first antenna 614a may be part of a subset of antennas in a first column (e.g., 306a in FIG. 3A) and second antenna 614b may be part of a subset of antennas in a second column (e.g., 306b). For example, as shown in FIG. 6, first antenna 614a and second antenna 614b may be mirrored with respect to each other across a line of symmetry (e.g., 302 in FIG. 3A).

In the illustrated example of FIG. 6, an epoxy molding compound is disposed between conductive layer 610 and semiconductor die 620. For example, the epoxy molding compound may be configured to protect semiconductor die 620. While the epoxy molding compound may result in losses in embodiments where an antenna array is integrated on semiconductor die 620, antenna array 612 of integrated circuit 600 may be configured to transmit and/or receive with low loss at least in part due to the epoxy molding compound being disposed between antenna array 612 and semiconductor die 620. In the illustrated example, interconnects 640 include first via portions (“Cu stud”) through the epoxy molding compound and second via portions in a via layer between conductive layer 610 and the epoxy molding compound, which differ in diameter from the first vias. Other via configurations, such as having the same diameter in both first and second via portions, may be used.

In the illustrated example of FIG. 6, another conductive layer 650 is shown disposed between semiconductor die 620 and mounting interface 630. For example, conductive layer 650 may be configured as an RDL configured to route signals from mounting interface 630 to circuitry on semiconductor die 620. In the illustrated example of FIG. 6, a protective layer (Pl) is disposed between conductive layer 650 and the UBM layer of mounting interface 630.

In the illustrated example of FIG. 6, a via layer (“vial layer”) is further disposed between semiconductor die 620 and conductive layer 650, and a die attach film is disposed between semiconductor die 620 and the via layer.

FIG. 7A illustrates a conductive layer of a further alternative example integrated circuit 700 that may be included in the transmitter 320 of FIG. 3A and/or the receiver 430 of FIG. 4A, in accordance with some embodiments of the technology described herein.

In some embodiments, integrated circuit 700 may be configured as described herein for integrated circuit 500 and/or 600. For example, as shown in FIG. 7A, integrated circuit 700 includes a conductive layer 710 having an antenna array 712. In the illustrated example of FIG. 7A, antenna array 712 includes patch antennas 714, which may be configured as described herein for first antenna 614a and second antenna 614b. For example, as shown in FIG. 7A, the patch antennas 714 are mirrored with respect to one another. Further shown in FIG. 7A, integrated circuit 700 includes feed vias 716, which may be configured as described herein for interconnects 540a and 540b and/or interconnects 640.

FIG. 7B illustrates the conductive layer 710 and a semiconductor die 720 of integrated circuit 700, in accordance with some embodiments of the technology described herein. In FIG. 7B, the integrated circuit 700 is shown in cross-section along line A in FIG. 7A.

As shown in FIG. 7B, feed via 716 is electrically coupled between patch antenna 714 and semiconductor die 720. For example, feed via 716 may be electrically coupled to transmit and/or receive circuitry on semiconductor die 720, such as to feed patch antenna 714 for transmission and/or reception of RF signals. In the illustrated example of FIG. 7B, semiconductor die 720 includes feed routing 722 on a side of semiconductor die adjacent conductive layer 710, which may be electrically coupled to transmit and/or receive circuitry.

### Interface Circuitry

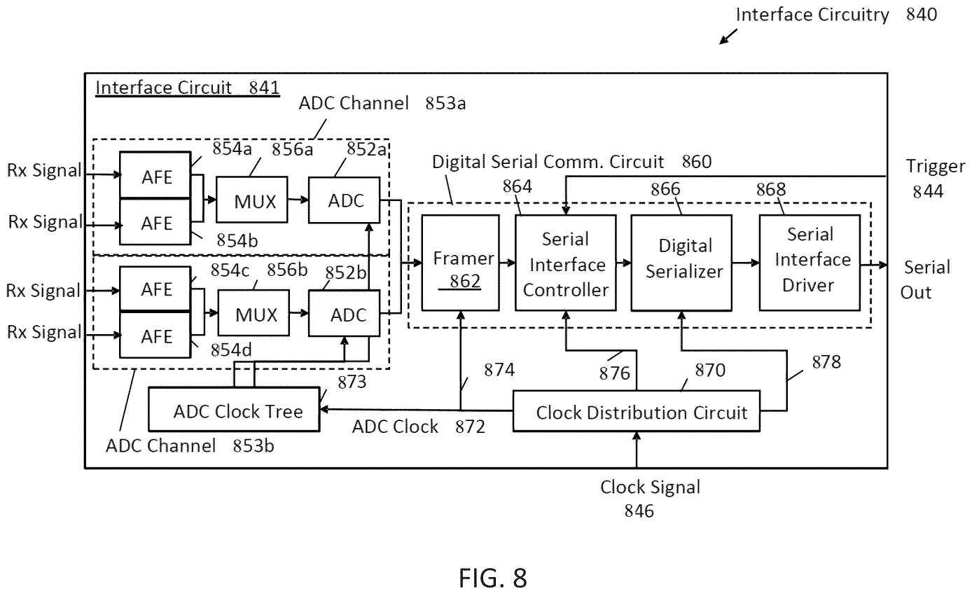

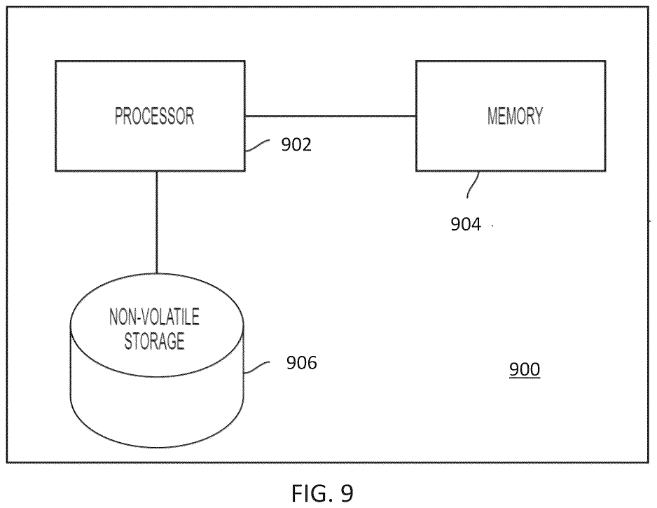

FIG. 8 illustrates example interface circuitry 840 that may be included in radar device 200, in accordance with some embodiments of the technology described herein.

In some embodiments, interface circuitry 840 may be configured as described herein for interface circuitry 240 including in connection with FIG. 2. As shown in FIG. 8, interface circuitry 840 includes an interface integrated circuit 841. For instance, as shown in FIG. 8, interface integrated circuit 841 includes time-division multiplexing circuitry including first time-division multiplexer 856a and second time-division multiplexer 856b, as well as ADC circuitry including first ADC circuit 852a and second ADC circuit 852b.

In some embodiments, first time-division multiplexer 856a may be coupled to first and second receive elements (e.g., 438 in FIG. 4A) and configured to combine first and second processed RF signals, obtained from the first and second receive channels, into a first single time-division multiplexed signal, and second time-division multiplexer 856b may be coupled to third and fourth receive channels and configured to combine third and fourth processed RF signals, obtained from the third and fourth receive channels, into a second single time-division multiplexed signal. In some embodiments, a time-division multiplexer may be included in the time-division multiplexing circuitry for each pair of receive channels that interface integrated circuit 841 is coupled to (e.g., for each pair of receive elements of a receive semiconductor die, e.g., 438, to which interface integrated circuit 841 is coupled to). In some embodiments, time-division multiplexing a first number of receive channels into a second, lesser number of ADC channels may reduce power and space consumed in digitizing processed RF signals for routing and further downstream processing.

In some embodiments, operation of ADC circuitry of interface integrated circuit 841 may be synchronized using a clock signal. For example, as shown in FIG. 8, interface integrated circuit 841 includes a clock distribution circuit 870 configured to receive clock signal 846 (e.g., from processing circuitry, e.g., 210) and provide an ADC clock signal 872 to the ADC circuitry via an ADC clock tree 873. For instance, ADC clock tree 873 may be configured to equalize propagation delays in ADC clock signal 872 in conductive paths to respective ADC circuits (e.g., 852a and 852b) so as to synchronize sampling by the ADC circuitry.

In some embodiments, interface circuitry 840 may further include amplification circuitry coupled between receive channels and the time-division multiplexing circuitry. For example, as shown in FIG. 8, interface circuitry 840 further includes first analog front-end (AFE) circuitry 854a, second AFE circuitry 854b, third AFE circuitry 854c, and fourth AFE circuitry 854d, which may include amplification circuitry. For instance, first AFE circuitry 854a may include a first amplifier coupled between a first receive channel and first time-division multiplexer 856a and second AFE circuitry 854b may include a second amplifier coupled between a second receive channel and first time-division multiplexer 856a. Similarly, third AFE circuitry 854c may include a third amplifier coupled between a third receive channel and second time-division multiplexer 856b and fourth AFE circuitry 854d may include a fourth amplifier coupled between a fourth receive channel and fourth time-division multiplexer 856d. In some embodiments, each of AFE circuitry 854a-854d may include a high-pass filter, a preamplifier, a programmable-gain amplifier (PGA), an anti-aliasing filter, and a unity-gain buffer, though it should be appreciated that other configurations are possible.

In some embodiments, each of AFE circuitry 854a-854d may be configured to receive an intermediate frequency (IF) processed RF signal from a respective receive channel, such as having a bandwidth of less than 10 MHz (e.g., 5 MHz) and may be configured to provide the processed RF signal. In some embodiments, ADC circuits 852a-852b may be configured to perform digital sampling at a rate of 20 million samples per second (MSPs), though other ADC configurations are possible. In the illustrated example, first AFE circuitry 854a, second AFE circuitry 854b, first time-division multiplexer 856a, and first ADC circuitry 852a provide a first ADC channel 853a, and third AFE circuitry 854c, fourth AFE circuitry 854d, second time-division multiplexer 856b, and second ADC circuitry 852b provide a second ADC channel 853b.

As further shown in FIG. 8, interface integrated circuit 841 includes digital serial communication circuitry 860, which includes serial interface controller 864 and framer 862. In some embodiments, framer 862 may be configured to provide a first frame (e.g., a single period of RF signal reception and/or a sequence of periods corresponding to a transmit scan) of first processed RF signals to serial interface controller 864 in response to trigger signal 844. For example, the first processed RF signals may be obtained from a first plurality of receive channels digitized via first ADC circuitry 852a.

As further shown in FIG. 8, digital serial communication circuitry 860 further includes a digital serializer 866, which may be configured to combine a first single digitized time-division multiplexed signal (e.g., obtained from first ADC circuitry 852a) a second single digitized time-division multiplexed signal (e.g., obtained from second ADC circuitry 852b) into a single digital serial signal. For instance, digital serializer 866 may be configured to obtain the digitized time-division multiplexed signals represented by respective groups of parallel digital bits and serialize the groups of parallel digital bits into a single digital bit stream. Also shown in FIG. 8, digital serial communication circuitry further includes a serial interface driver 868, which may be configured to transmit the single digital serial signal from interface circuitry 850 (e.g., via the substrate of the device). For example, serial interface driver 868 may be configured to transmit the signal using a low-voltage differential signaling (LVDS) protocol.

In some embodiments, operation of digital serial communication circuitry 4260 may be synchronized using a clock signal. For example, as shown in FIG. 8, clock distribution circuit 870 may be configured to provide clock signals 874, 876, and 878 to framer 862, serial interface controller 864, and digital serializer 866, respectively. For instance, clock signals 874, 876, and 878 may have different clock rates, such as due to the higher clock rates that may be used for serialization as compared to framing digitized RF signals from the ADC circuitry.

While only a single interface integrated circuit 841 is shown in FIG. 8, it should be appreciated that multiple interface integrated circuits 841 may be included in a device (e.g., 200). For example, as shown in FIG. 8, interface integrated circuit 841 may be configured to receive trigger signal 844 and clock signal 846, such as provided (e.g., by processing circuitry of the device) to multiple or all interface integrated circuits of the device to synchronize operation of interface circuitry 840. For instance, each interface integrated circuit may be configured as described herein for interface integrated circuit 841. In some embodiments, serialized processed RF signals offloaded from the interface integrated circuits may include data for one frame. For example, the processing circuitry may be configured to combine the serialized processed RF signals into a consolidated frame, such as to beamform processed RF signals serialized from respective receive channels of the receiver.

### Processing Circuitry

FIG. 9 illustrates an example computer system 900 that may be configured to perform at least some processing operations in a radar device (e.g., 200 in FIG. 2), in accordance with some embodiments of the technology described herein.

An illustrative implementation of a computer system 900 that may be used in connection with any of the embodiments of the disclosure provided herein is shown in FIG. 9. For example, in some embodiments, operations described herein including in connection with FIG. 1 may be performed using the computer system 900 (e.g., implemented using processing circuitry mounted on and/or coupled to a substrate of a device). The computer system 900 may include one or more processors 902 and one or more articles of manufacture that comprise non-transitory computer-readable storage media (e.g., memory 904 and one or more non-volatile storage media 906). The processor 902 may control writing data to and reading data from the memory 904 and the non-volatile storage device 906 in any suitable manner, as the aspects of the disclosure provided herein are not limited in this respect. To perform any of the functionality described herein, the processor 902 may execute one or more processor-executable instructions stored in one or more non-transitory computer-readable storage media (e.g., the memory 904), which may serve as non-transitory computer-readable storage media storing processor-executable instructions for execution by the processor 902.

### Example Aspects

According to a first example aspect of the present disclosure, a radar device comprises: a substrate defining a plane extending in a first direction and in a second direction substantially orthogonal to the first direction; and a transmitter comprising a transmit integrated circuit mounted on the substrate, the transmit integrated circuit comprising: a first conductive layer comprising a transmit antenna array, the transmit antenna array comprising a plurality of transmit RF antennas; and a transmit semiconductor die disposed between the first conductive layer and the substrate, the transmit semiconductor die having integrated thereon transmit circuitry configured to cause at least some of the plurality of transmit RF antennas to transmit first RF signals having a center frequency in a range between 150 GHz and 1.5 THz.

In some embodiments, in the first example aspect, the first RF signals have a center frequency in a range between 300 GHz and 320 THz.

In some embodiments, in the first example aspect, the transmit integrated circuit further comprises a second conductive layer disposed between the transmit semiconductor die and the substrate.

In some embodiments, in the first example aspect, each of the plurality of transmit RF antennas comprises a patch antenna.

In some embodiments, in the first example aspect, the plurality of transmit RF antennas are arranged in a first column along the first direction and a second column along the first direction, the first column comprises a first subset of the plurality of transmit RF antennas and the second column comprises a second subset of the plurality of transmit RF antennas; and the first subset of the plurality of transmit RF antennas are mirrored with respect to the second subset of the plurality of transmit RF antennas across a line of symmetry.

In some embodiments, in the first example aspect, the radar device further comprises a receiver comprising a receive integrated circuit mounted on the substrate and comprising: a receive antenna array comprising a plurality of receive RF antennas; and receive circuitry configured to receive second RF signals via the plurality of receive RF antennas, the second RF signals being generated, at least in part, based on reflection of the first RF signals from a target object.

In some embodiments, in the first example aspect, the receive integrated circuit comprises: a first conductive layer comprising the receive antenna array; and a receive semiconductor die disposed between the first conductive layer and the substrate and having the receive circuitry integrated thereon.

In some embodiments, in the first example aspect, the radar device further comprises signal generation circuitry mounted on the substrate and configured to generate third RF signals, wherein the transmit circuitry is configured to generate the first RF signals using the third RF signals, and wherein the receive circuitry is configured to mix the second RF signals with the third RF signals to obtain fourth RF signals.

In some embodiments, in the first example aspect, the radar device further comprises processing circuitry mounted on the substrate and configured to determine, based on the fourth RF signals, a distance from the radar device to the target object.

In some embodiments, in the first example aspect, the transmitter comprises a plurality of transmit integrated circuits mounted on the substrate and spaced at a distance from one another in the first direction, the plurality of transmit integrated circuits comprising the transmit integrated circuit, and each of the plurality of transmit integrated circuits comprising: a first conductive layer comprising a transmit antenna array comprising a plurality of transmit RF antennas; and a transmit semiconductor die disposed between the first conductive layer and the substrate and having integrated thereon transmit circuitry configured to transmit, via the plurality of transmit RF antennas, first RF signals having a center frequency in a range between 150 GHz and 1.5 THz.

In some embodiments, in the first example aspect, the transmit circuitry comprises a transmit amplifier and a frequency multiplier.

In some embodiments, in the first example aspect, the transmit integrated circuit comprises a plurality of vias electrically coupled between the plurality of transmit RF antennas and the transmit circuitry.

According to a second example aspect of the present disclosure, a radar device comprises: a substrate defining a plane extending in a first direction and a second direction substantially orthogonal to the first direction; a transmitter comprising a transmit integrated circuit mounted on the substrate, comprising: a first conductive layer comprising a transmit antenna array, the transmit antenna array comprising a plurality of transmit RF antennas; and a transmit semiconductor die disposed between the first conductive layer and the substrate and having integrated thereon transmit circuitry configured to cause at least some of the plurality of transmit RF antennas to transmit first RF signals having a center frequency in a range between 150 GHz and 1.5 THz; and a receiver comprising a receive integrated circuit mounted on the substrate, the receive integrated circuit comprising: a first conductive layer comprising a receive antenna array comprising a plurality of receive RF antennas; and a receive semiconductor die disposed between the first conductive layer and the substrate and having integrated thereon receive circuitry configured to receive, via the plurality of receive RF antennas, second RF signals generated, at least in part, by reflection of the first RF signals off of a target object.

In some embodiments, in the second example aspect, the radar device further comprises processing circuitry mounted on the substrate and configured to determine, based on the second RF signals, a distance between the radar device and the target object.

In some embodiments, in the second example aspect, the radar device further comprises interface circuitry mounted on the substrate, wherein the receive circuitry is configured to process the second RF signals to obtain third RF signals, the interface circuitry is configured to digitize the third RF signals to obtain fourth RF signals, and the processing circuitry is configured to determine the distance based on the fourth RF signals.

In some embodiments, in the second example aspect, the transmit integrated circuit further comprises a second conductive layer disposed between the transmit semiconductor die and the substrate.

In some embodiments, in the second example aspect, each of the plurality of transmit RF antennas comprises a patch antenna.

In some embodiments, in the second example aspect, each of the plurality of receive RF antennas comprises a patch antenna.

In some embodiments, in the second example aspect, the plurality of transmit RF antennas are arranged in a first column along the first direction and a second column along the first direction, the first column comprises a first subset of the plurality of transmit RF antennas and the second column comprises a second subset of the plurality of transmit RF antennas; and the first subset of the plurality of transmit RF antennas are mirrored with respect to the second subset of the plurality of transmit RF antennas across a line of symmetry.

In some embodiments, in the second example aspect, the radar device further comprises signal generation circuitry mounted on the substrate and configured to generate third RF signals, wherein the transmit circuitry is configured to generate the first RF signals using the third RF signals, and wherein the receive circuitry is configured to mix the second RF signals with the third RF signals to obtain fourth RF signals.

In some embodiments, in the second example aspect, the transmitter comprises a plurality of transmit integrated circuits mounted on the substrate and spaced at a distance from one another in the first direction, the plurality of transmit integrated circuits comprising the transmit integrated circuit, and each of the plurality of transmit integrated circuits comprising: a first conductive layer comprising a transmit antenna array comprising a plurality of transmit RF antennas; and a transmit semiconductor die disposed between the first conductive layer and the substrate and having integrated thereon transmit circuitry configured to transmit, via the plurality of transmit RF antennas, first RF signals having a center frequency in a range between 150 GHz and 1.5 THz; and the receiver comprises a plurality of receive integrated circuits mounted on the substrate and spaced at a distance from one another in the second direction, the plurality of receive integrated circuits comprising the receive integrated circuit, and each of the plurality of receive integrated circuits comprising: a first conductive layer comprising a receive antenna array comprising a plurality of receive RF antennas; and a receive semiconductor die having integrated thereon receive circuitry configured to receive, via the plurality of receive RF antennas, second RF signals generated, at least in part, by reflection of the first RF signals off of a target object.

In some embodiments, in the second example aspect, the transmit circuitry comprises a transmit amplifier and a frequency multiplier.

In some embodiments, in the second example aspect, the transmit integrated circuit comprises a plurality of vias electrically coupled between the plurality of transmit RF antennas and the transmit circuitry.

In some embodiments, in the second example aspect, the first RF signals have a center frequency in a range between 300 GHz and 320 THz.

According to a third example aspect of the present disclosure, a radar device, comprises: a substrate defining a plane extending in a first direction and in a second direction substantially orthogonal to the first direction; and a receiver comprising a receive integrated circuit mounted on the substrate, the receive integrated circuit comprising: a first conductive layer comprising a receive antenna array, the receive antenna array comprising a plurality of receive RF antennas; and a receive semiconductor die disposed between the first conductive layer and the substrate, the receive semiconductor die having integrated thereon receive circuitry configured to receive, via at least some of the plurality of receive RF antennas, first RF signals having a center frequency in a range between 150 GHz and 1.5 THz.

In some embodiments, in the third example aspect, the first RF signals have a center frequency in a range between 300 GHz and 320 THz.

In some embodiments, in the third example aspect, the receive integrated circuit further comprises a second conductive layer disposed between the receive semiconductor die and the substrate.

In some embodiments, in the third example aspect, each of the plurality of receive RF antennas comprises a patch antenna.

In some embodiments, in the third example aspect, the radar device further comprises a transmitter comprising a transmit integrated circuit mounted on the substrate and comprising: a transmit antenna array comprising a plurality of transmit RF antennas; and transmit circuitry configured to cause the plurality of transmit RF antennas to transmit second RF signals, the first RF signals being generated, at least in part, based on reflection of the second RF signals from a target object.

In some embodiments, in the third example aspect, the transmit integrated circuit comprises: a first conductive layer comprising the transmit antenna array; and a transmit semiconductor die disposed between the first conductive layer and the substrate and having the transmit circuitry integrated thereon.

In some embodiments, in the third example aspect, the radar device further comprises signal generation circuitry mounted on the substrate and configured to generate third RF signals, wherein the transmit circuitry is configured to generate the second RF signals using the third RF signals, and wherein the receive circuitry is configured to mix the first RF signals with the third RF signals to obtain fourth RF signals.

In some embodiments, in the third example aspect, the radar device further comprises processing circuitry mounted on the substrate and configured to determine, based on the fourth RF signals, a distance from the radar device to the target object.

In some embodiments, in the third example aspect, the receiver comprises a plurality of receive integrated circuits mounted on the substrate and spaced at a distance from one another in the second direction, the plurality of receive integrated circuits comprising the receive integrated circuit, and each of the plurality of receive integrated circuits comprising: a first conductive layer comprising a receive antenna array comprising a plurality of receive RF antennas; and a receive semiconductor die disposed between the first conductive layer and the substrate and having integrated thereon receive circuitry configured to receive, via the plurality of receive RF antennas, first RF signals having a center frequency in a range between 150 GHz and 1.5 THz.

In some embodiments, in the third example aspect, the receive circuitry comprises a receive amplifier and a frequency mixer.

In some embodiments, in the third example aspect, the receive integrated circuit comprises a plurality of vias electrically coupled between the plurality of receive RF antennas and the receive circuitry.

According to a fourth example aspect of the present disclosure, a radar device comprises: a substrate defining a plane extending in a first direction and in a second direction substantially orthogonal to the first direction; and an integrated circuit mounted on the substrate, the integrated circuit comprising: a first conductive layer comprising an antenna array, the antenna array comprising a plurality of RF antennas; and a semiconductor die disposed between the first conductive layer and the substrate, the semiconductor die having integrated thereon circuitry configured to transmit and/or receive, via at least some of the plurality of RF antennas, first RF signals having a center frequency in a range between 150 GHz and 1.5 THz.

In some embodiments, in the fourth example aspect, the antenna array comprises a transmit antenna array and the semiconductor die comprises transmit circuitry configured to transmit the first RF signals via the at least some of the plurality of RF antennas.

In some embodiments, in the fourth example aspect, the antenna array comprises a receive antenna array and the semiconductor die comprises receive circuitry configured to receive the first RF signals via the at least some of the plurality of RF antennas.

In some embodiments, in the fourth example aspect, the antenna array comprises a transmit and receive antenna array; the semiconductor die comprises transmit circuitry configured to transmit a first subset of the first RF signals via the at least some of the plurality of RF antennas; the semiconductor die comprises receive circuitry configured to receive a second subset of the first RF signals via the at least some of the plurality of RF antennas; and the second subset of the first RF signals are generated, at least in part, by reflection of the first subset of the first RF signal off of a target object.

According to a fifth example aspect of the present disclosure, an integrated circuit for a radar device comprises: a mounting interface; a first conductive layer comprising an antenna array, the antenna array comprising a plurality of RF antennas; and a semiconductor die disposed between the first conductive layer and the mounting interface, the semiconductor die having integrated thereon circuitry configured to transmit and/or receive, via at least some of the plurality of RF antennas, first RF signals having a center frequency in a range between 150 GHz and 1.5 THz.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor, but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

What is claimed is:

1. A radar device, comprising:
a substrate defining a plane extending in a first direction and in a second direction substantially orthogonal to the first direction; and
a transmitter comprising a transmit integrated circuit mounted on the substrate, the transmit integrated circuit comprising:
a first conductive layer comprising a transmit antenna array, the transmit antenna array comprising a plurality of transmit RF antennas; and
a transmit semiconductor die disposed between the first conductive layer and the substrate, the transmit semiconductor die having integrated thereon transmit circuitry configured to cause at least some of the plurality of transmit RF antennas to transmit first RF signals having a center frequency in a range between 150 GHz and 1.5 THz.

2. The radar device of claim 1, wherein the first RF signals have a center frequency in a range between 300 GHz and 320 THz.

3. The radar device of claim 1, wherein the transmit integrated circuit further comprises a second conductive layer disposed between the transmit semiconductor die and the substrate.

4. The radar device of claim 1, wherein each of the plurality of transmit RF antennas comprises a patch antenna.

5. The radar device of claim 1, wherein:
the plurality of transmit RF antennas are arranged in a first column along the first direction and a second column along the first direction,
the first column comprises a first subset of the plurality of transmit RF antennas and the second column comprises a second subset of the plurality of transmit RF antennas; and
the first subset of the plurality of transmit RF antennas are mirrored with respect to the second subset of the plurality of transmit RF antennas across a line of symmetry.

6. The radar device of claim 1, wherein the transmitter comprises a plurality of transmit integrated circuits mounted on the substrate and spaced at a distance from one another in the first direction, the plurality of transmit integrated circuits comprising the transmit integrated circuit, and each of the plurality of transmit integrated circuits comprising:
a first conductive layer comprising a transmit antenna array comprising a plurality of transmit RF antennas; and
a transmit semiconductor die disposed between the first conductive layer and the substrate and having integrated thereon transmit circuitry configured to transmit, via the plurality of transmit RF antennas, first RF signals having a center frequency in a range between 150 GHz and 1.5 THz.

7. The radar device of claim 1, wherein the transmit circuitry comprises a transmit amplifier and a frequency multiplier.

8. The radar device of claim 1, wherein the transmit integrated circuit comprises a plurality of vias electrically coupled between the plurality of transmit RF antennas and the transmit circuitry.

9. A radar device, comprising:
a substrate defining a plane extending in a first direction and a second direction substantially orthogonal to the first direction;
a transmitter comprising a transmit integrated circuit mounted on the substrate, comprising:
a first conductive layer comprising a transmit antenna array, the transmit antenna array comprising a plurality of transmit RF antennas; and
a transmit semiconductor die disposed between the first conductive layer and the substrate and having integrated thereon transmit circuitry configured to cause at least some of the plurality of transmit RF antennas to transmit first RF signals having a center frequency in a range between 150 GHz and 1.5 THz; and
a receiver comprising a receive integrated circuit mounted on the substrate, the receive integrated circuit comprising:
a first conductive layer comprising a receive antenna array comprising a plurality of receive RF antennas; and
a receive semiconductor die disposed between the first conductive layer and the substrate and having integrated thereon receive circuitry configured to receive, via the plurality of receive RF antennas, second RF signals generated, at least in part, by reflection of the first RF signals off of a target object.

10. The radar device of claim 9, further comprising processing circuitry mounted on the substrate and configured to determine, based on the second RF signals, a distance between the radar device and the target object.

11. The radar device of claim 10, further comprising interface circuitry mounted on the substrate, wherein the receive circuitry is configured to process the second RF signals to obtain third RF signals, the interface circuitry is configured to digitize the third RF signals to obtain fourth RF signals, and the processing circuitry is configured to determine the distance based on the fourth RF signals.

12. The radar device of claim 9, further comprising signal generation circuitry mounted on the substrate and configured to generate third RF signals, wherein the transmit circuitry is configured to generate the first RF signals using the third RF signals, and wherein the receive circuitry is configured to mix the second RF signals with the third RF signals to obtain fourth RF signals.

13. The radar device of claim 9, wherein the first RF signals have a center frequency in a range between 300 GHz and 320 THz.

14. A radar device, comprising:
a substrate defining a plane extending in a first direction and in a second direction substantially orthogonal to the first direction; and
a receiver comprising a receive integrated circuit mounted on the substrate, the receive integrated circuit comprising:
a first conductive layer comprising a receive antenna array, the receive antenna array comprising a plurality of receive RF antennas; and
a receive semiconductor die disposed between the first conductive layer and the substrate, the receive semiconductor die having integrated thereon receive circuitry configured to receive, via at least some of the plurality of receive RF antennas, first RF signals having a center frequency in a range between 150 GHz and 1.5 THz.

15. The radar device of claim 14, wherein the first RF signals have a center frequency in a range between 300 GHz and 320 THz.

16. The radar device of claim 14, wherein the receive integrated circuit further comprises a second conductive layer disposed between the receive semiconductor die and the substrate.

17. The radar device of claim 14, wherein each of the plurality of receive RF antennas comprises a patch antenna.

18. The radar device of claim 14, wherein the receiver comprises a plurality of receive integrated circuits mounted on the substrate and spaced at a distance from one another in the second direction, the plurality of receive integrated circuits comprising the receive integrated circuit, and each of the plurality of receive integrated circuits comprising:
a first conductive layer comprising a receive antenna array comprising a plurality of receive RF antennas; and
a receive semiconductor die disposed between the first conductive layer and the substrate and having integrated thereon receive circuitry configured to receive, via the plurality of receive RF antennas, first RF signals having a center frequency in a range between 150 GHz and 1.5 THz.

19. The radar device of claim 14, wherein the receive circuitry comprises a receive amplifier and a frequency mixer.

20. The radar device of claim 14, wherein the receive integrated circuit comprises a plurality of vias electrically coupled between the plurality of receive RF antennas and the receive circuitry.
